(19) United States
(12) Patent Application Publication
(10) Pub. No.: US 2020/0326453 A1
(43) Pub. Date: Oct. 15, 2020

(54) PHOTO EYE CIRCUIT WITH BREWSTER POLARIZER

(71) Applicant: Bastian Solutions, LLC, Indianapolis, IN (US)

(72) Inventors: Daniel R. Marshall, Boise, ID (US); Timothy R. Nelson, Boise, ID (US); Tiffany Lee Greyson, Boise, ID (US)

(73) Assignee: Bastian Solutions, LLC, Indianapolis, IN (US)

(21) Appl. No.: 15/929,254

(22) Filed: Apr. 7, 2020

Related U.S. Application Data
(60) Provisional application No. 62/831,771, filed on Apr. 10, 2019.

(51) Int. Cl. G01V 8/14; G01J 1/04; G01J 1/42

(52) U.S. Cl. CPC G01V 8/14; B65G 43/08; G01J 1/42; G01J 1/0429

(57) ABSTRACT

A photoelectric sensor system includes a photoelectric sensor and a retroreflector that is positioned to reflect light emitted by the photoelectric sensor. The photoelectric sensor includes a polarized light source that emits p-polarized light. The photoelectric sensor further includes a Brewster polarizer that is oriented at a Brewster's angle to further polarize the emitted light. The emitted light beam emitted by the photoelectric sensor is reflected off the retroreflector and polarized ninety degrees by the retroreflector to have s-polarization. The reflected light beam is reflected off the Brewster polarizer to a laterally offset light detector.

### CROSS REFERENCE TO RELATED APPLICATIONS

This application claims the benefit of U.S. Provisional Patent Application No. 62/831,771, filed on Apr. 10, 2019, which is hereby incorporated by reference.

### BACKGROUND

With many types of sensors, detection accuracy is always a concern. These errors can be especially pronounced with photo eye or optical type sensors. These detection errors in turn can cause improper operation of conveyors and other equipment using the sensors. Such photo eye sensors can be quite expensive and prone to damage. In typical installations, such as for conveyors in warehouses or manufacturing plants, hundreds or even thousands of these sensors may be required which can significantly impact the cost and reliability of the overall system.

Thus, there is a need for improvement in this field.

### SUMMARY

Traditional photo eye sensors typically detect an object, such as an item on a conveyor, by sensing whether an emitted light beam is interrupted. In some cases, the traditional sensor emits a beam of light that is reflected from a reflector back to the sensor. However, it was discovered that such traditional sensor systems have difficulty in detecting the presence of shiny objects, such as mirrors, shiny metal objects, or shiny glass objects (e.g., bottles), because the objects reflect a significant amount of the light back to the sensor. With the emitted light being reflected back, the sensor is unable to detect the shiny object. In essence, these shiny objects are invisible to traditional photo eye sensors. Moreover, light pollution is a concern with traditional photo eyes. Stray light can shine on the photo eye so as to blind the sensor.

Among other things, a unique photoelectric sensor system has been developed to detect highly reflective or shiny objects as well as other objects. The photoelectric sensor system includes a polarized light source, a Brewster polarizer, a retroreflector, and a light detector. The polarized light source in one form is a laser beam generator. By using the laser to generate the light, the resulting laser beam is naturally polarized. In one form, the laser beam is p-polarized relative to the Brewster polarizer so that the beam can pass through the Brewster polarizer. The laser beam from the laser hits the Brewster polarizer at the Brewster's angle such that the Brewster polarizer act as a polarizing filter for the transmitted laser beam as well as any light reflected back from the retroreflector. For the emitted p-polarized beam, the Brewster polarizer helps to clean up the polarization. With the laser beam being emitted at the p-polarization, the retroreflector changes the linear polarization of the reflected light by ninety degrees(90°) to s-polarization. The now reflected s-polarized light hits the Brewster polarizer at the Brewster's angle which in turn causes the s-polarized light to reflect towards the light detector. By using the light reflected from the Brewster polarizer, the light detector may be placed in an isolated location away from most of the returning light. In one form, the light detector is oriented at an offset position that is transverse or perpendicular to the transmitted laser beam. With this arrangement, the system helps to prevent sensor errors caused by light pollution. It should be recognized that this elegant design can be inexpensively manufactured. For example, the same glass sheet forming the Brewster polarizer acts as a polarizing filter for both the transmitted and received light.

The photoelectric sensor system is able to detect an object when the reflected light beam is interrupted, even by shiny objects. Again, the photoelectric sensor emits the emitted light beam as p-polarized light. The retroreflector changes the p-polarized light ray from the photoelectric sensor to the s-polarized light ray forming the reflected light beam. With the Brewster polarizer reflecting the reflected light beam, the light detector is only able to detect the s-polarized light ray. Unlike the retroreflector, the reflective or shiny object does not change the polarization of the reflected light beam such that any light reflected from the shiny object has the same p-polarization as the emitted light beam. When at least one highly reflective or shiny object passes between the photoelectric sensor and the retroreflector, the reflected light beam remains at the p-polarization. With the reflected light beam being p-polarized, the Brewster polarizer at the Brewster's angle does not reflect the light towards the light detector. Consequently, the light detector is able to detect the lower intensity or interruption of the light so as to detect the shiny object.

Aspect 1 generally concerns a system that includes a retroreflector and a Brewster polarizer to reflect light from the retroreflector onto a light detector.

Aspect 2 generally concerns the system of aspect 1 in which the polarized light source is positioned to emit an emitted light beam with a first polarization towards the retroreflector.

Aspect 3 generally concerns the system of aspect 2 in which the polarized light source is positioned to shine the emitted light beam through the Brewster polarizer.

Aspect 4 generally concerns the system of aspect 3 in which the retroreflector reflects the emitted light beam to form a reflected light beam having a second polarization.

Aspect 5 generally concerns the system of aspect 4 in which the second polarization is oriented 90° from the first polarization.

Aspect 6 generally concerns the system of aspect 5 in which the Brewster polarizer is positioned to reflect the second polarization onto the light detector.

Aspect 7 generally concerns the system of aspect 6 in which the first polarization is p-polarization and the second polarization is s-polarization.

Aspect 8 generally concerns the system of aspect 2 in which the polarized light source includes a laser.

Aspect 9 generally concerns the system of aspect 2 in which the light detector is positioned laterally offset relative to a focal axis of the polarized light source.

Aspect 10 generally concerns the system of aspect 9 in which the light detector has a light detection surface that faces the focal axis.

Aspect 11 generally concerns the system of aspect 10 that includes a circuit board to which the light detector and the polarized light source are secured.

Aspect 12 generally concerns the system of aspect 11 that includes a housing with a board guide in which the circuit board is received.

Aspect 13 generally concerns the system of aspect 11 in which the indicator is operatively coupled to the circuit board.

Aspect 14 generally concerns the system of aspect 1 in which the Brewster polarizer includes an optics support supporting an optical plate at a Brewster's angle.

Aspect 15 generally concerns the system of aspect 14 in which the optical plate includes a glass plate.

Aspect 16 generally concerns the system of aspect 14 in which the optics support includes a pinhole wall defining a pinhole through which the light travels to the light sensor.

Aspect 17 generally concerns the system of aspect 16 in which a lens is positioned between the Brewster polarizer and retroreflector to collimate the light through the pinhole.

Aspect 18 generally concerns the system of aspect 14 which includes a housing with one or more support pins to align the optics support in the housing.

Aspect 19 generally concerns the system of aspect 18 in which the housing has at least three of the support pins.

Aspect 20 generally concerns the system of aspect 14 in which the optics support has an overall triangular funnel shape.

Aspect 21 generally concerns the system of aspect 1 in which the polarizer is positioned between the Brewster polarizer and the light detector.

Aspect 22 generally concerns the system of aspect 1 in which the light detector includes a photodiode.

Aspect 23 generally concerns the system of any previous aspect in which the polarized light source is positioned to emit an emitted light beam with a first polarization towards the retroreflector.

Aspect 24 generally concerns the system of any previous aspect in which the polarized light source is positioned to shine the emitted light beam through the Brewster polarizer.

Aspect 25 generally concerns the system of any previous aspect in which the retroreflector reflects the emitted light beam to form a reflected light beam having a second polarization.

Aspect 26 generally concerns the system of any previous aspect in which the second polarization is oriented 90° from the first polarization.

Aspect 27 generally concerns the system of any previous aspect in which the Brewster polarizer is positioned to reflect the second polarization onto the light detector.

Aspect 28 generally concerns the system of any previous aspect in which the first polarization is p-polarization and the second polarization is s-polarization.

Aspect 29 generally concerns the system of any previous aspect in which the polarized light source includes a laser.

Aspect 30 generally concerns the system of any previous aspect in which the light detector is positioned laterally offset relative to a focal axis of the polarized light source.

Aspect 31 generally concerns the system of any previous aspect in which the light detector has a light detection surface that faces the focal axis.

Aspect 32 generally concerns the system of any previous aspect which includes a circuit board to which the light detector and the polarized light source are secured.

Aspect 33 generally concerns the system of any previous aspect which includes a housing with a board guide in which the circuit board is received.

Aspect 34 generally concerns the system of any previous aspect in which the indicator is operatively coupled to the circuit board.

Aspect 35 generally concerns the system of any previous aspect in which the Brewster polarizer includes an optics support supporting an optical plate at a Brewster's angle.

Aspect 36 generally concerns the system of any previous aspect in which the optical plate includes a glass plate.

Aspect 37 generally concerns the system of any previous aspect in which the optics support includes a pinhole wall defining a pinhole through which the light travels to the light sensor.

Aspect 38 generally concerns the system of any previous aspect in which the lens is positioned between the Brewster polarizer and retroreflector to collimate the light through the pinhole.

Aspect 39 generally concerns the system of any previous aspect which includes a housing with one or more support pins to align the optics support in the housing.

Aspect 40 generally concerns the system of any previous aspect in which the housing has at least three of the support pins.

Aspect 41 generally concerns the system of any previous aspect in which the optics support has an overall triangular funnel shape.

Aspect 42 generally concerns the system of any previous aspect in which the polarizer is positioned between the Brewster polarizer and the light detector.

Aspect 43 generally concerns the system of any previous aspect in which the light detector includes a photodiode.

Aspect 44 generally concerns a method of operating the system of any previous aspect.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a diagrammatic view of a photoelectric sensor system according to one example.

FIG. 2 is a side view of one example of a photoelectric sensor and retroreflector that can be used in the FIG. 1 photoelectric sensor system.

FIG. 3 is a front view of the FIG. 2 retroreflector.

FIG. 4 is a front perspective view of the FIG. 2 photoelectric sensor.

FIG. 5 is a rear perspective view of the FIG. 2 photoelectric sensor.

FIG. 6 is a bottom view of the FIG. 2 photoelectric sensor.

FIG. 7 is a side view of the FIG. 2 photoelectric sensor.

FIG. 8 is a front view of the FIG. 2 photoelectric sensor.

FIG. 9 is a side exploded view of the FIG. 2 photoelectric sensor.

FIG. 10 is a rear exploded view of the FIG. 2 photoelectric sensor.

FIG. 11 is a cross-sectional view of the FIG. 2 photoelectric sensor.

FIG. 12 is a side perspective view of a housing body of the FIG. 2 photoelectric sensor.

FIG. 13 is a cross-sectional view of the FIG. 12 housing body.

FIG. 14 is a perspective view of a cover of the FIG. 2 photoelectric sensor.

FIG. 15 is a rear perspective view of an optics support of the FIG. 2 photoelectric sensor.

FIG. 16 is a front perspective view of the FIG. 15 optics support.

FIG. 17 is a top view of the FIG. 15 optics support.

FIG. 18 is a cross-sectional view of the FIG. 15 optics support.

FIG. 19 is a front perspective view of selected optical components of the FIG. 2 photoelectric sensor.

FIG. 20 is a top perspective view of selected optical components of the FIG. 2 photoelectric sensor.

FIG. 21 is a side view of light being polarized by a Brewster polarizer in the FIG. 2 photoelectric sensor.

FIG. 22 is a side view of light being emitted by the FIG. 2 photoelectric sensor.

FIG. 23 is a side view of the emitted light beam being reflected by the FIG. 2 retroreflector.

FIG. 24 is a first side view of the reflected light beam being detected by the FIG. 2 photoelectric sensor.

FIG. 25 is a second side view of the reflected light beam being detected by the FIG. 2 photoelectric sensor.

FIG. 26 is a side view of another example of a photoelectric sensor and retroreflector that can be used in the FIG. 1 photoelectric sensor system.

FIG. 27 is a side view of the optical path of light for the photoelectric sensor and retroreflector.

### DETAILED DESCRIPTION OF SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein, are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

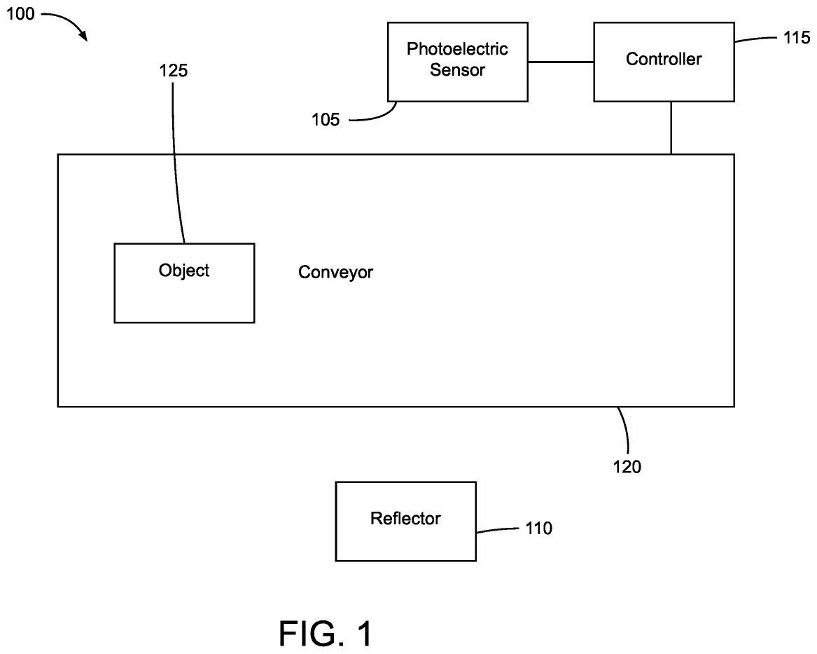

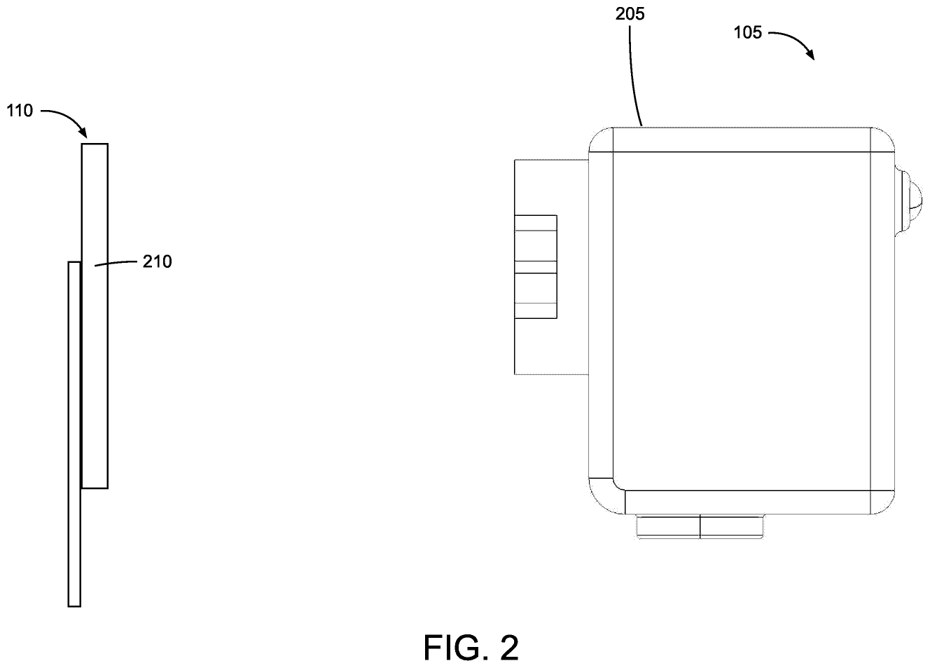

The reference numerals in the following description have been organized to aid the reader in quickly identifying the drawings where various components are first shown. In particular, the drawing in which an element first appears is typically indicated by the left-most digit(s) in the corresponding reference number. For example, an element identified by a “100” series reference numeral will likely first appear in FIG. 1, an element identified by a “200” series reference numeral will likely first appear in FIG. 2, and so on.

FIG. 1 shows a block diagram of a photoelectric sensor system 100 according to one example. As shown, the photoelectric sensor system 100 includes a photoelectric sensor 105 that is aligned with a reflector 110. The photoelectric sensor 105 is operatively connected to a controller 115 that processes signals from the photoelectric sensor 105 to control the operation of equipment, such as a conveyor 120 shown in FIG. 1. The conveyor 120, which is operatively connected to the controller 115, is used to move or convey one or more objects 125.

In the depicted example, the photoelectric sensor 105 and reflector 110 are positioned on opposite sides of the conveyor 120 to detect the presence or absence of the objects 125 moving along the conveyor 120. The photoelectric sensor 105 shines light (e.g., visible or infrared light) across the conveyor 120 which is reflected off the reflector 110 back to the photoelectric sensor 105. The photoelectric sensor 105 is configured to detect the presence or absence (and/or intensity) of the reflected light. Based on the presence and/or intensity of the reflected light, the photoelectric sensor 105 is then able to sense whether one or more of the objects 125 are located on the conveyor 120 between the photoelectric sensor 105 and the reflector 110. In one example, the photoelectric sensor 105 detects the objects 125 when the light transmitted by the photoelectric sensor 105 and/or reflected by the reflector 110 is blocked or interrupted by the object 125 such that no or very little light reflected by the reflector 110 is detected by the photoelectric sensor 105.

As noted before, shiny objects 125 can cause detection errors because light from the photoelectric sensor 105 can reflect off the shiny object 125 and back into the photoelectric sensor 105. If a sufficient intensity of light is reflected, traditional photo sensors would not be able to detect the presence of the shiny object 125. As will be explained in further detail below, the photoelectric sensor system 100 is configured to detect objects 125, even shiny ones, with higher accuracy by utilizing the polarization property of the light.

FIG. 2 shows a side view of one example of the photoelectric sensor 105 and reflector 110 that can be used in the photoelectric sensor system 100. In the illustrated example, a photoelectric sensor 205 is positioned to reflect light off the reflector 110 which is in the form of a retroreflector 210. The retroreflector 210 is able to reflect the light (i.e., radiation) back to the photoelectric sensor 205 with minimum scattering. The light reflected from the retroreflector 210 is quasi-collimated so as to focus the light back to the photoelectric sensor 205. As will be explained below, the photoelectric sensor 205 is designed to utilize this quasi-collimated light from the retroreflector 210 to enhance detection accuracy. In one form, the photoelectric sensor 205 includes a prismatic type reflector.

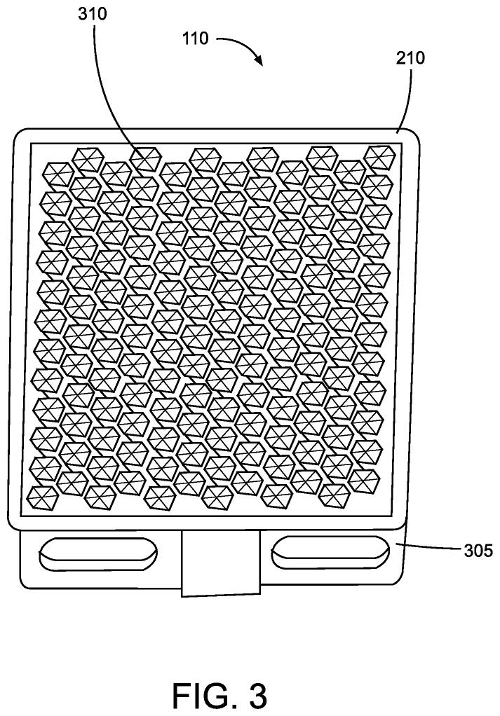

FIG. 3 illustrates one design of the retroreflector 210 that can be used in the photoelectric sensor system 100. As can be seen, the retroreflector 210 includes a frame 305 that supports a reflector section 310. The frame 305 supports the reflector section 310 and is designed to be secured to other structures such as the conveyor 120. The reflector section 310 is configured to reflect the light back to the photoelectric sensor 205. The reflector section 310 for instance can include corner reflector, cat's eye, and/or phase-conjugate mirror type retroreflector surfaces.

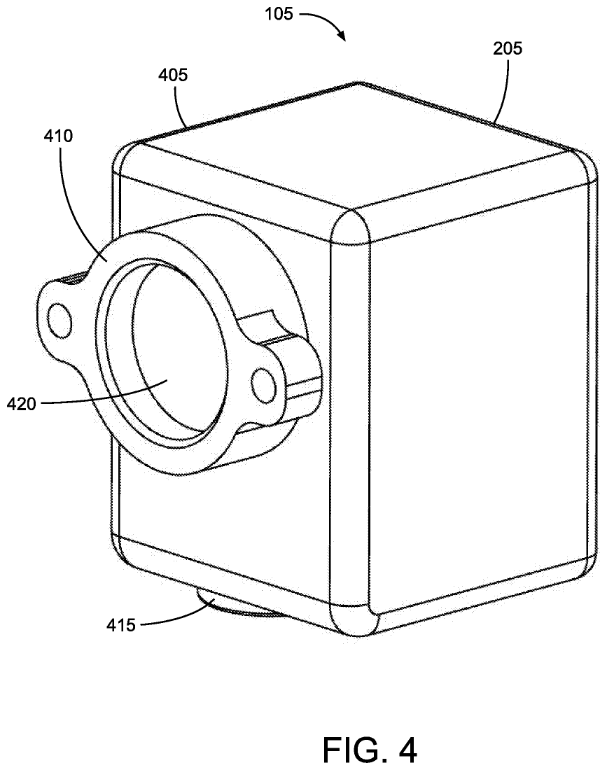

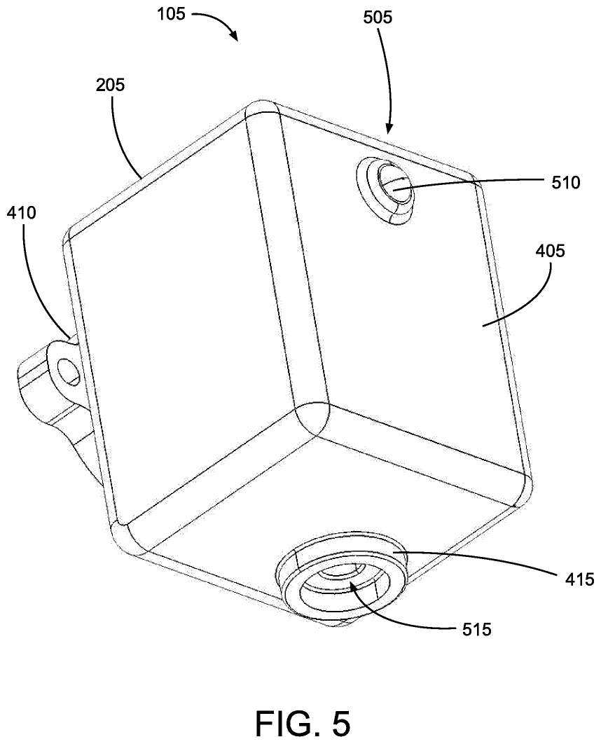

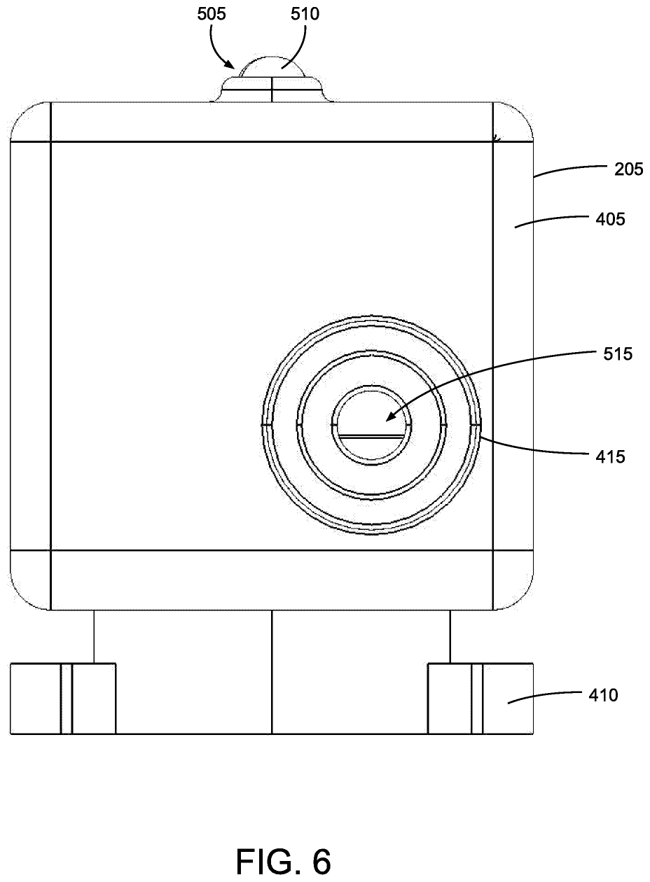

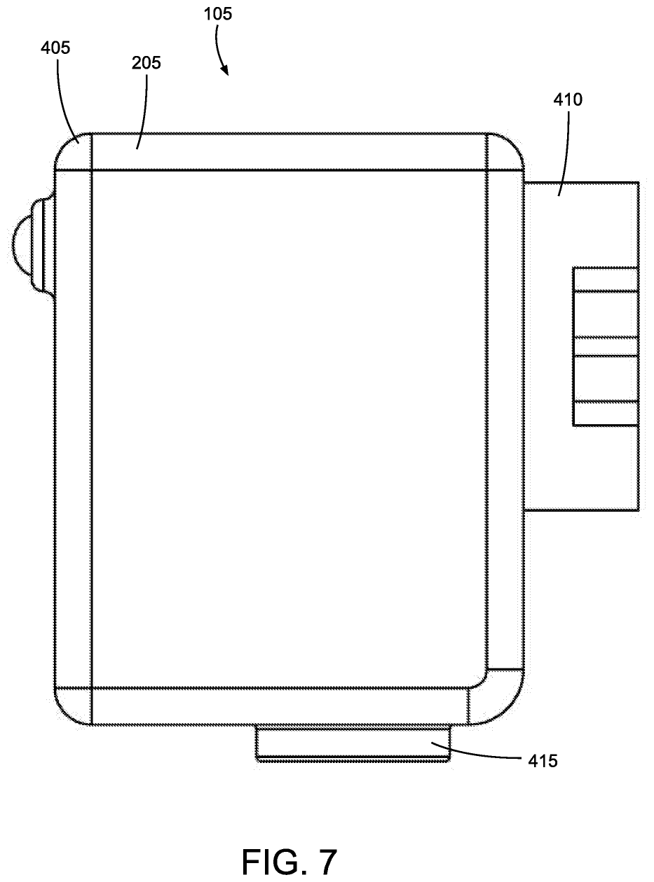

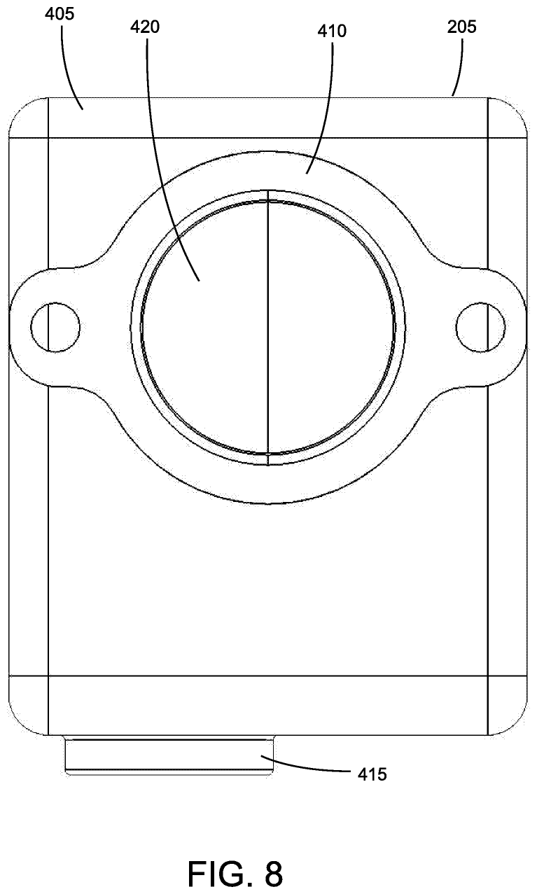

Turing to FIGS. 4, 5, 6, 7, and 8, the photoelectric sensor 205 includes a housing 405 with a lens section 410 and mount section 415. The lens section 410 holds a lens 420 through which light from the photoelectric sensor 205 is transmitted and received. In one form, the lens 420 is a glass and/or plastic plano-concave lens, but other types of lenses and materials can be used. Looking at FIG. 5, the photoelectric sensor 205 includes an output device 505 in the form of an indicator 510 such as a Light Emitting Diode (LED). The indicator 510 can for example indicate the presence or absence of reflected light being sensed or other operational parameters. The mount section 415 further defines a connector opening 515 through which a wire, cable, or other connector from the controller is operatively connected to the internal electronics of the photoelectric sensor 205.

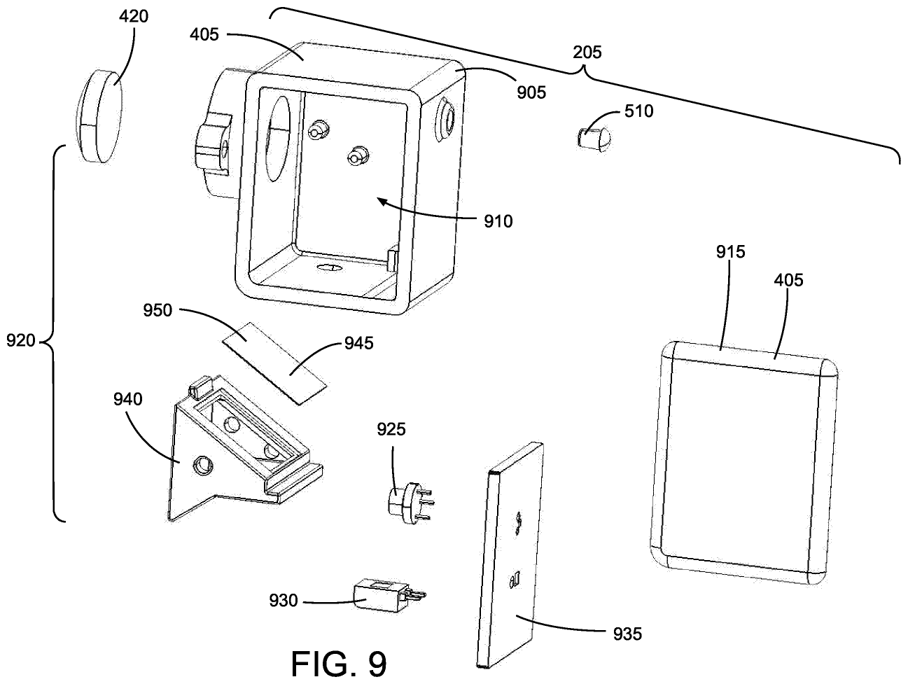

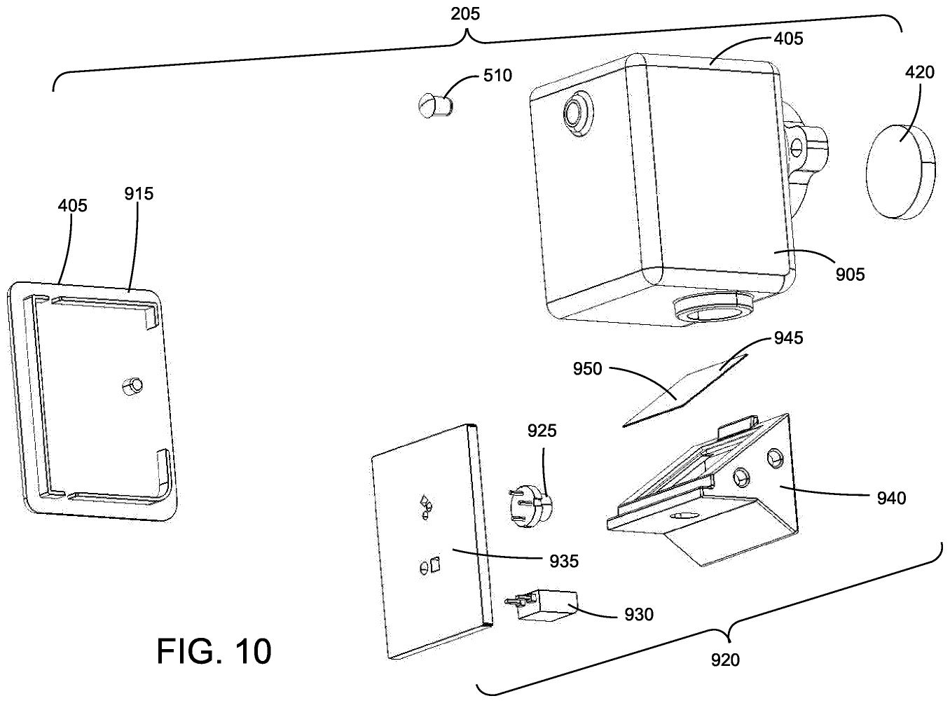

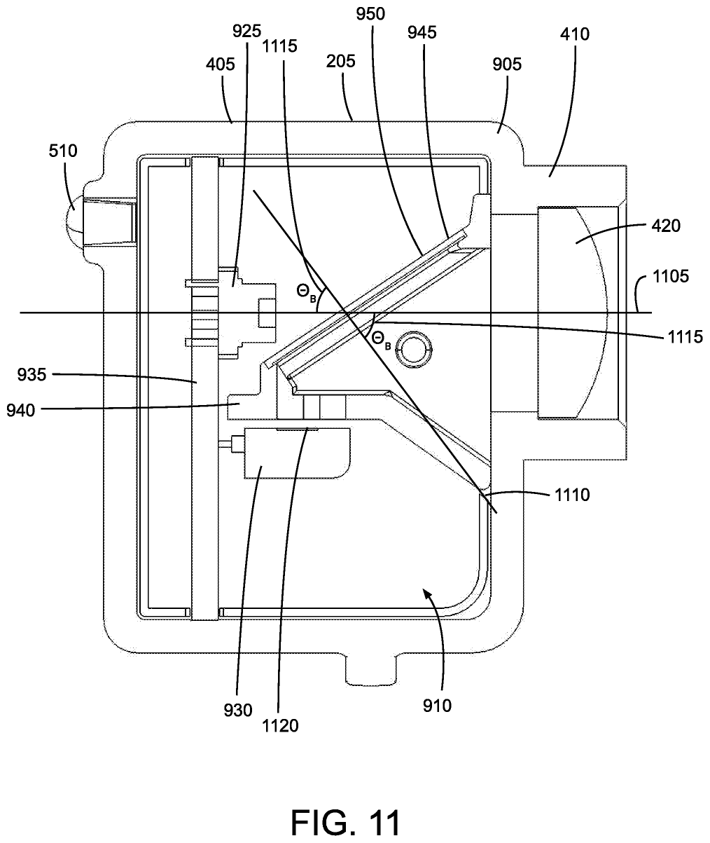

FIGS. 9 and 10 respectively show first and second exploded views of the photoelectric sensor 205, and FIG. 11 shows a cross-sectional view of the photoelectric sensor 205. The housing 405 includes a housing body 905 with a body cavity 910 in which the various components of the photoelectric sensor 205 are received. The housing 405 further includes a cover 915 that is secured to the housing body 905 to enclose the components inside the housing 405. The photoelectric sensor 205 further has an optics system 920 that is used to generate the light and detect the light reflected from the retroreflector 210. In addition to the lens 420, the optics system 920 includes a polarized light source 925 and a light detector 930 mounted to a circuit board 935. The polarized light source 925 is designed to emit polarized light. In the illustrated example, the polarized light source 925 is a laser beam generator (or laser for short) because the generated laser light is generally polarized. In other examples, the polarized light source 925 can be replaced with a non-polarized light source with polarizing filters to polarize the light. The light detector 930 in the depicted example is a photodiode, but other types of light sensors can be used in other examples. The indicator 510 is also operatively connected to the circuit board 935, and the circuit board 935 is operatively connected to the controller 115 through a wire or other connector passing through the connector opening 515 in the mount section 415 of the photoelectric sensor 205.

The optics system 920 of the photoelectric sensor 205 further includes an optics support 940 that holds or supports a Brewster polarizer 945 within the body cavity 910 of the housing 405. The Brewster polarizer 945 in one example normally does not include any type of polarization filter material and is generally clear. Instead of using polarizing filters, the optics support 940 holds the Brewster polarizer 945 at a Brewster's angle or polarization angle (OB) relative to the focal axis of the lens 420 to polarize the light. With the Brewster polarizer 945 oriented at the Brewster's angle, the light can be readily polarized without the need of additional filters. Not only does this simplify the construction and reduce the cost of the photoelectric sensor 205, this construction enhances accuracy of the photoelectric sensor 205. The Brewster polarizer 945 in the illustrated example includes a single optical plate 950, but in other examples, the Brewster polarizer 945 includes multiple optical plates 950 stacked at the Brewster's angle. The optical plate 950 in one form is a clear sheet of glass, but the optical plate 950 can be made of other optical grade materials such as a clear plastic sheet or window.

Referring to FIG. 11, the polarized light source 925 and lens 420 are generally aligned along a focal axis 1105. The Brewster polarizer 945 has a normal axis 1110 that extends perpendicular to the surface of the Brewster polarizer 945. The angle of incidence between the focal axis 1105 and the normal axis 1110 is at a Brewster's angle 1115 (Θ_{B}). With the Brewster polarizer 945 being held by the optics support 940 at the Brewster's angle 1115, the light reflected by the retroreflector 210 is again polarized when reflected by the Brewster polarizer 945 towards the light detector 930. In one form, the Brewster polarizer 945 is a clear, flat glass sheet, but other types of dielectric materials, such as plastic, can be used in other examples. When the optical plate 950 is made of glass, the Brewster's angle 1115 is around 56° to 57° (e.g., 56.3°), but the Brewster's angle 1115 varies depending on the optical material forming the Brewster polarizer 945. As will be explained in greater detail, having the optical plate 950 oriented at the Brewster's angle 1115 allows the Brewster polarizer 945 to act as a polarizing filter for both the transmitted and received light. This in turn helps to eliminate the need for extra polarizing filters. In essence, the single Brewster polarizer 945 does the work of two polarizing filters as well as provides additional benefits.

Having the Brewster polarizer 945 oriented at the Brewster's angle 1115 not only eliminates the need for extra polarizing filters, but it at the same time allows the light detector 930 to be oriented at a lateral orientation that is generally transverse to the focal axis 1105 of the lens 420, as is shown in FIG. 11. The light detector 930 in the depicted example is generally located below the polarized light source 925. The light detector 930 has a light detection surface 1120 that is configured to detect the presence and/or intensity of the light. The light detection surface 1120 of the light detector 930 is located generally offset from and faces the focal axis 1105 so that the light reflected from the Brewster polarizer 945 hits the light detection surface 1120. By being oriented in such a manner, there is a low risk of any significant amount of extraneous light hitting the light detection surface 1120 of the light detector 930 because the light detector 930 is not in the direct line of sight of the lens 420. With this configuration, the risk of detection errors (both false positives and false negatives) by the photoelectric sensor 205 is reduced.

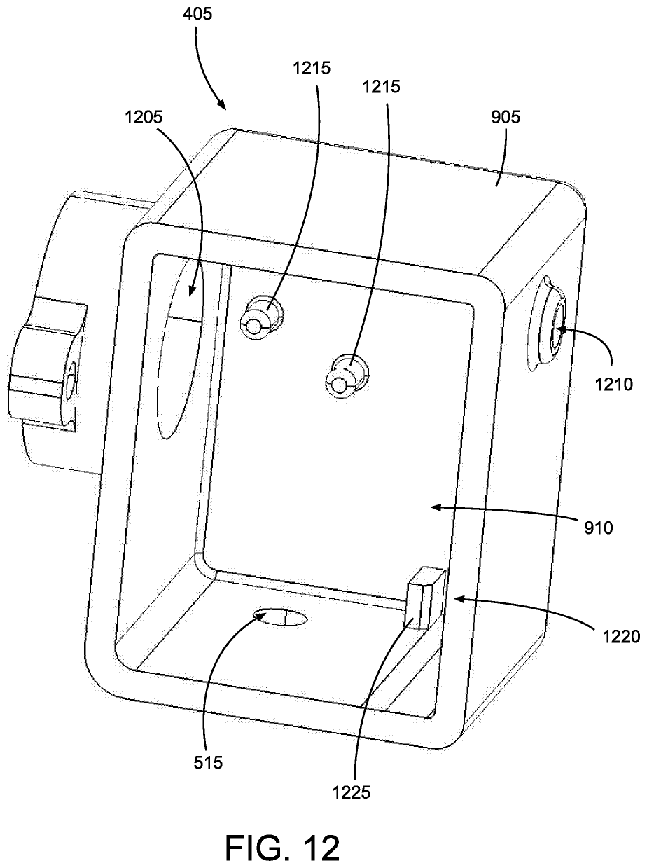

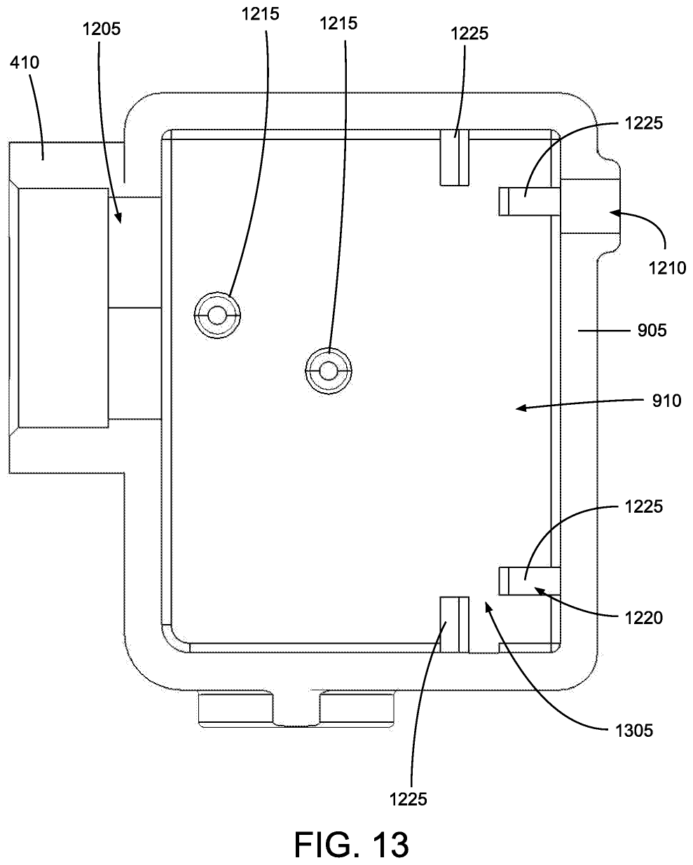

Referring now to FIGS. 12, 13, and 14, the housing body 905 defines an aperture 1205 through which light is sent to and received from the lens 420. When installed, the lens 420 in the lens section 410 covers the aperture 1205. Opposite the aperture 1205, the housing body 905 has at least one indicator opening 1210 where the indicator 510 is mounted to the housing body 905. Inside the body cavity 910, the housing body 905 has one or more support pins 1215 where the optics support 940 is secured inside the body cavity 910 of the housing body 905. In the illustrated example, the housing body 905 has two support pins 1215 that help orient the optics support 940 so that the Brewster polarizer 945 is oriented as the proper Brewster's angle 1115. To ensure the polarized light source 925 and light detector 930 are properly oriented relative to the Brewster polarizer 945, the housing 405 has a board guide 1220 with one or more guide tabs 1225 for aligning the circuit board 935 on which the polarized light source 925 and light detector 930 are mounted. In the illustrated example, the guide tabs 1225 define a guide slot 1305 (FIG. 13) in which the circuit board 935 is slidably received during installation.

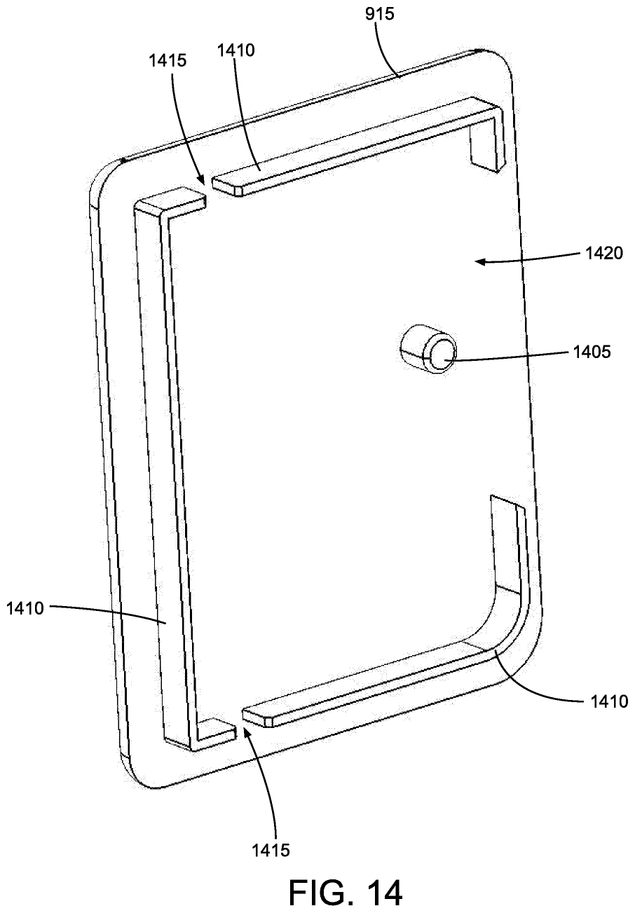

The cover 915 in FIG. 14 has structures for aligning the circuit board 935 and optics support 940. As can be seen, the cover 915 has at least one support pin 1405 that extends into the body cavity 910 of the housing 405. In the depicted example, the cover 915 has a single support pin 1405 to help simplify assembly by removing the difficulty associated with aligning multiple support pins 1405 with the corresponding openings in the optics support 940. In one form, the housing body 905 has two support pins 1215 and the cover 915 has one support pin 1405 so as to minimally provide three points of support and alignment in three-dimensional space of the optics support 940 within the body cavity 910. The side of the cover 915 that faces the body cavity 910 when closed further has one or more alignment flanges 1410 that help align the cover 915 with the housing body 905 during assembly. As shown, the alignment flanges 1410 define one or more guide slots 1415 in which the circuit board 935 is received when the photoelectric sensor 205 is assembled. The guide slots 1415 help to support and properly align the circuit board 935 so that the polarized light source 925 and light detector 930 are properly positioned. The cover 915 further has a support gap 1420 that receives one end of the optics support 940 when the photoelectric sensor 205 is assembled.

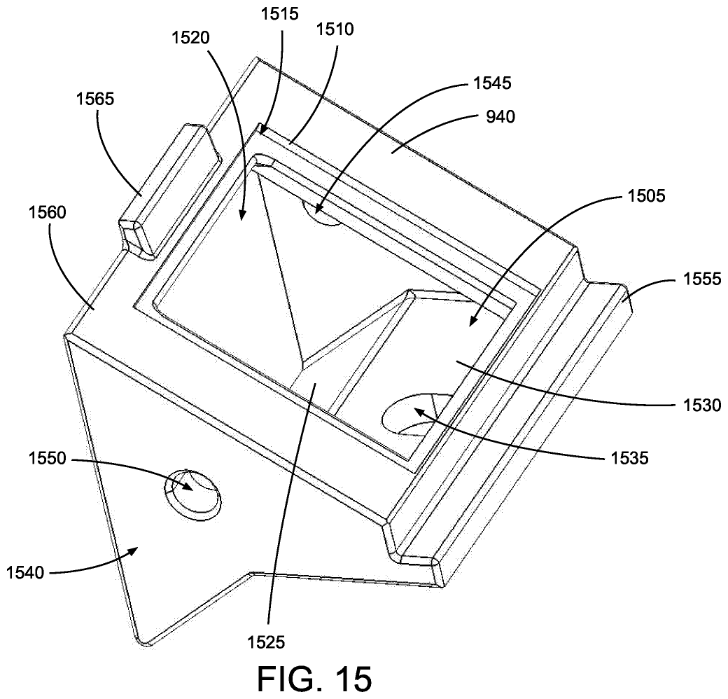

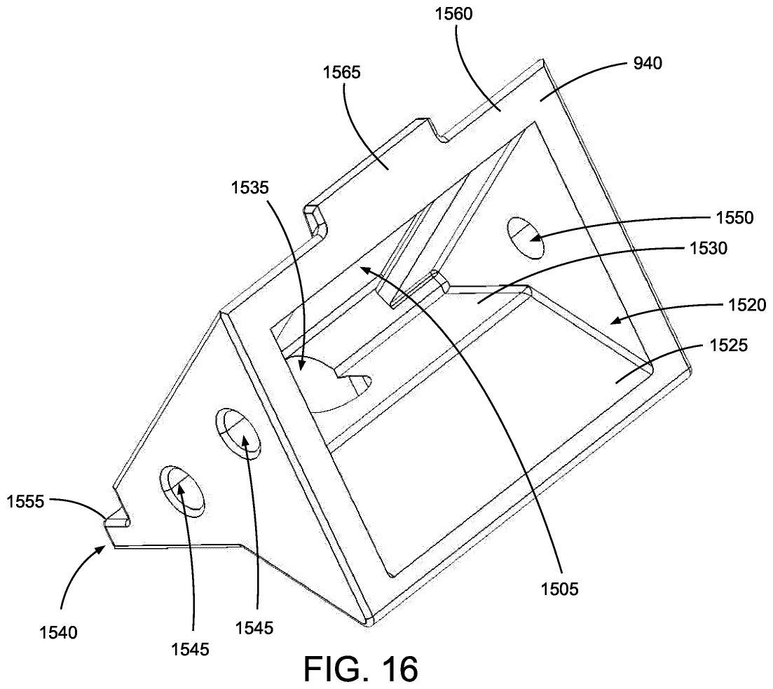

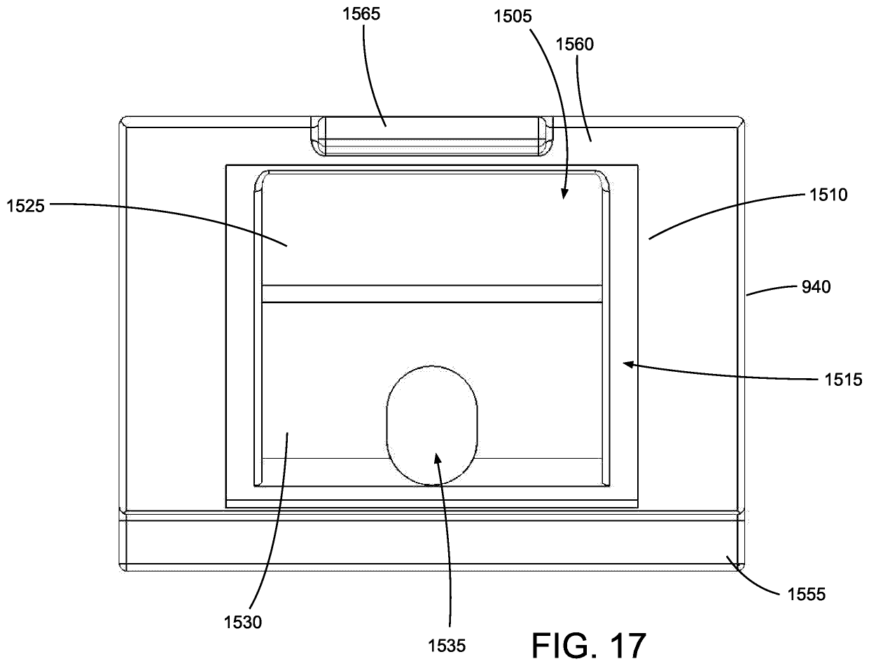

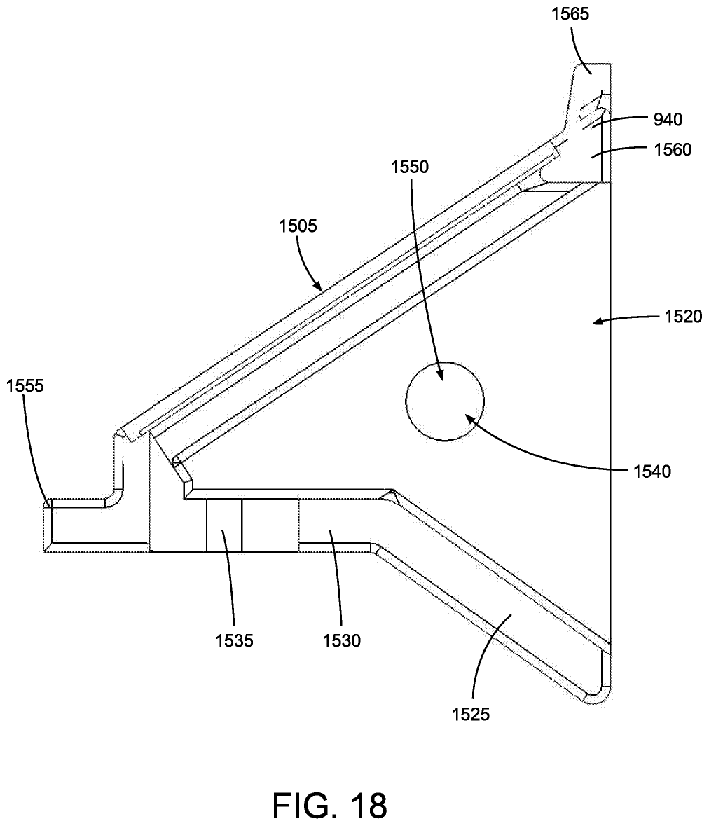

As illustrated in FIGS. 15, 16, 17, and 18, the optics support 940 has an overall funnel shape or triangular profile. The optics support 940 has a number of apertures through which light shines. For instance, the optics support 940 defines a window opening 1505 for the Brewster polarizer 945. Around the window opening 1505, the optics support 940 has a window frame 1510 that supports the optical plate 950. The window channel 1515 has a window channel 1515 in which the Brewster polarizer 945 is secured. In one form, the Brewster polarizer 945 is secured in the window channel 1515 of the window frame 1510 via an adhesive. The Brewster polarizer 945 can be secured in other ways such as via fasteners and/or snap connections. When the photoelectric sensor 205 is assembled, the window frame 1510 is angled at the Brewster's angle 1115 so that the optical plate 950 of the Brewster polarizer 945 is likewise oriented at the Brewster's angle 1115. The optics support 940 further defines a support aperture 1520 that faces the lens 420 when installed. Both the light transmitted by the polarized light source 925 and the reflected light from the retroreflector 210 travels through the support aperture 1520. The support aperture 1520 is relatively large to facilitate light collection.

Proximal to the light detector 930, the optics support 940 has a shade wall 1525 that shields the light detector 930 from extraneous light. The shade wall 1525 extends in a transverse angled manner to a pinhole wall 1530 that generally covers over the light detection surface 1120 of the light detector 930. As shown, the shade wall 1525 extends at an angle from the pinhole wall 1530. The pinhole wall 1530 generally extends in a manner parallel to (or horizontal to) the focal axis 1105 when in the housing 405 (FIG. 11). The pinhole wall 1530 shades the light detector 930 from extraneous light and other error sources. The pinhole wall 1530 defines a pinhole 1535 through where the light reflected from the Brewster polarizer 945 travels to the light detection surface 1120 of the light detector 930. The pinhole 1535 in the illustrated example has a slight elongated, oval shape to compensate for the angle of the reflected of light, but in other examples, the pinhole 1535 can be shaped differently to compensate for the angle of the light reflected from the Brewster polarizer 945. The pinhole 1535 is positioned so as to prevent or minimize extraneous light from being sensed by the light detector 930. The pinhole 1535 is shaped and positioned so that the polarized light reflected from the Brewster polarizer 945 lands on the light detection surface 1120 of the light detector 930. In other embodiments, as will be further explained below, the pinhole 1535 can be covered by a polarizing filter to further clean up the polarized light reflected from the Brewster polarizer 945 so as to ensure a cleaner signal and reduce sensing errors.

As can be seen, the support aperture 1520 is generally larger than the window opening 1505 as well as the pinhole 1535 to ensure a large amount of light is collected from the retroreflector 210. The window opening 1505 is comparable in size to the support aperture 1520 so as to increase light output and collection. As compared to the window opening 1505 and support aperture 1520, the pinhole 1535 is relatively small to enhance sensing accuracy.

On the lateral sides, the optics support 940 has one or more pin openings 1540. The pin openings 1540 ensure that the optics support 940 and Brewster polarizer 945 are properly oriented in the housing 405 so that the optical plate 950 is positioned at the Brewster's angle 1115 relative to the polarized light source 925 and light detector 930. In particular, the pin openings 1540 include one or more body pin openings 1545 on one side of the optics support 940 configured to receive the support pins 1215 in the housing body 905 and one or more cover pin openings 1550 configured on the opposite side of the optics support 940 to receive the support pins 1405 of the cover 915. In the illustrated example, the optics support 940 includes two (2) body pin openings 1545 to coincide with the support pins 1215 in the housing body 905 and one (1) cover pin opening 1550 to coincide with the support pin 1405 of the cover 915. Once more, having a single cover pin opening 1550 makes it easier to align and secure the cover 915 to the housing body 905. Moreover, the provided three-point contact ensures the optics support 940 and Brewster polarizer 945 are spatially oriented in a proper manner.

To further aid with alignment of the Brewster polarizer 945 within the body cavity 910, the optics support 940 includes a board contact rail 1555 that is positioned proximal to the circuit board 935. Opposite the board contact rail 1555, the optics support 940 further has a housing contact face 1560 that contacts the inner wall of the housing 405 proximal to the lens section 410. At the housing contact face 1560, the window frame 1510 has an alignment tab 1565. As shown, the alignment tab 1565 extends from the window frame 1510 to aid in alignment.

As noted before, the optics support 940 is designed to readily assemble with the housing 405 so that the optical plate 950 of the Brewster polarizer 945 is properly positioned at the Brewster's angle 1115.

During assembly, the circuit board 935 with the polarized light source 925 and light detector 930 is slid into the guide slot 1305 in the body cavity 910 that is formed by the guide tabs 1225 in the housing body 905. The Brewster polarizer 945 is secured to the optics support 940, and the optics support 940 is inserted into the body cavity 910 of the housing body 905 with the support pins 1215 of the housing body 905 being received in the body pin openings 1545 of the optics support 940.

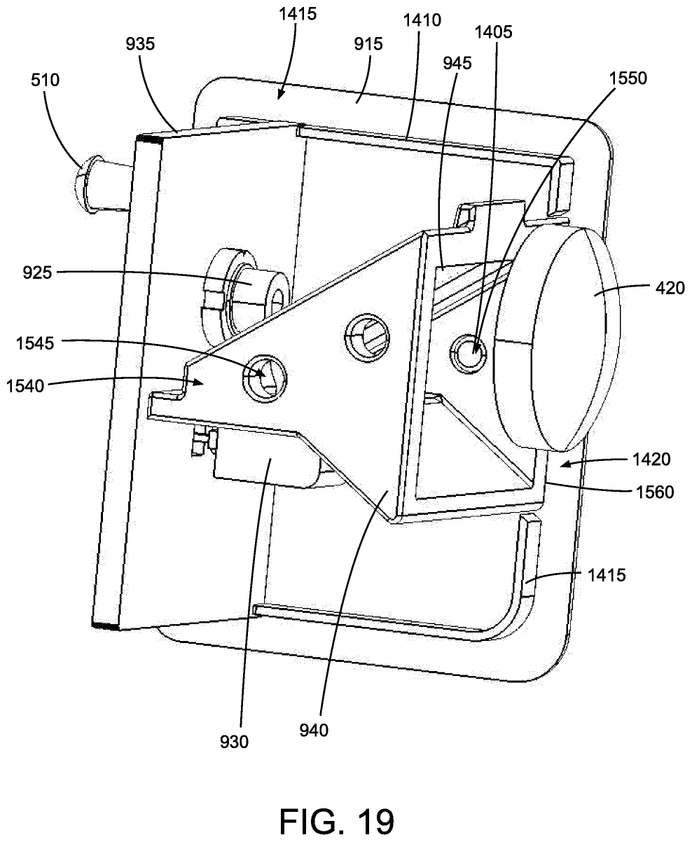

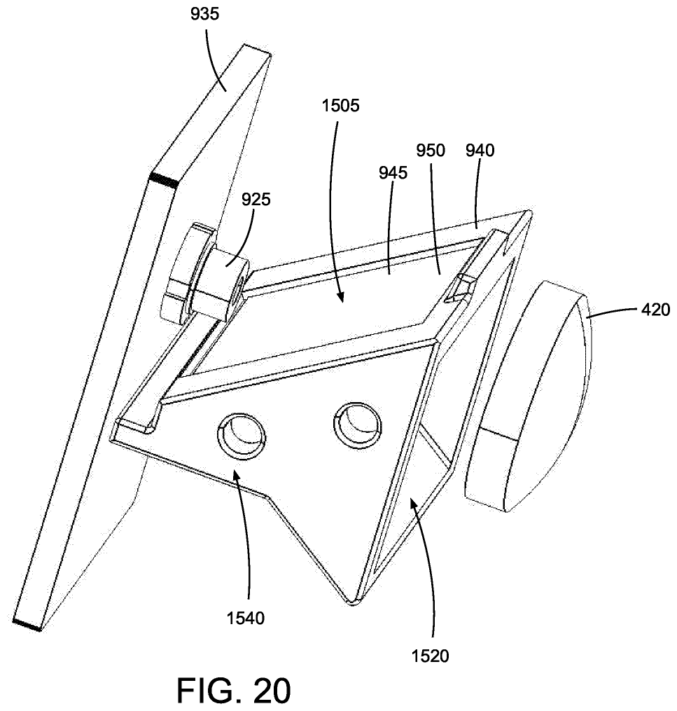

Referring to FIGS. 19 and 20, the optics support 940 is inserted in an orientation where the polarized light source 925 is positioned proximal to the Brewster polarizer 945, and the light detector 930 is positioned proximal to the pinhole 1535. Once the internal optical components are housed inside the body cavity 910, the cover 915 is secured to the housing body 905. Once more the alignment flanges 1410 of the cover 915 help align the cover 915 with the housing body 905. As shown in FIG. 19, the circuit board 935 is received in the guide slot 1415 formed between the alignment flanges 1410. The housing contact face 1560 is positioned in the support gap 1420 between the alignment flanges 1410. The cover 915 can be secured to the cover 915 in any number of manners, such as via an adhesive, fasteners, and/or ultrasonic welds, to name just a few examples. The lens 420 can be installed in the lens section 410 before, during, or after assembly of the other internal components of the photoelectric sensor 205.

As should be recognized, the photoelectric sensor 205 can be easily assembled while at the same time maintaining a high positional accuracy such that the optical plate 950 of the Brewster polarizer 945 is positioned at the Brewster's angle 1115 relative to the polarized light source 925 and light detector 930. Once more, such a design eliminates the need for extra polarizers which in turn enhances the reliability of the photoelectric sensor 205. A single sheet of clear glass (i.e., the Brewster polarizer 945) polarizes both the transmitted and received light so as to enhance detection accuracy. In addition, the Brewster polarizer 945 redirects the reflected light beam from the retroreflector 210 to further reduce the risk of extraneous light pollution on the light detector 930. As will be explained below, extra polarizers can be incorporated into the photoelectric sensor 105 in other examples so as to enhance light detection.

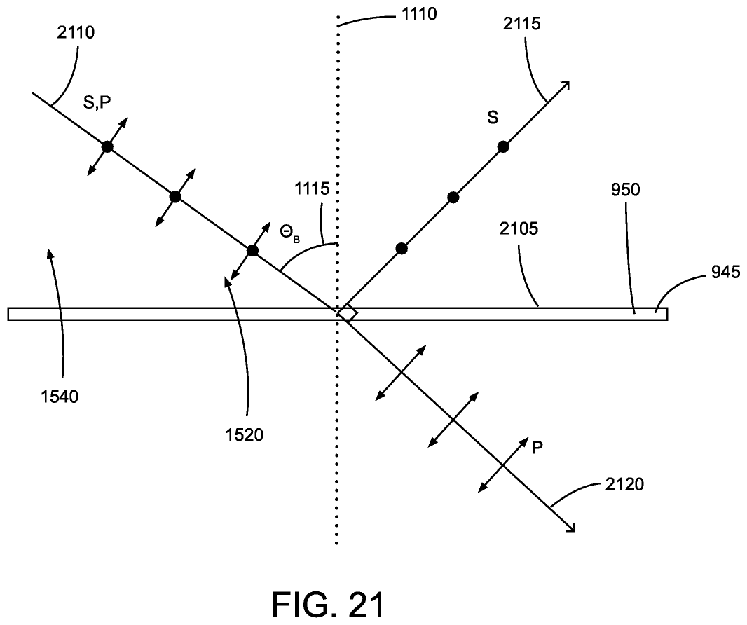

A technique for operating the photoelectric sensor 205 will now be initially described with reference to FIGS. 21, 22, 23, 24, and 25. Once more, the optics system 920 of the photoelectric sensor 205 holds or supports the Brewster polarizer 945 within the body cavity 910 of the housing 405. The optical plate 950 in one form is a clear sheet of glass or plastic. In the depicted example, the Brewster polarizer 945 is a type of reflective polarizer. The Brewster polarizer 945 in one example normally does not include any type of polarizing filter material, such as in a wire grid polarizer or a dichroic polarizer, and is generally clear (or in some cases tinted). Instead of using polarizing filters, the photoelectric sensor 205 uses the reflective properties of the Brewster polarizer 945 to polarize the light. In particular, the optics support 940 holds the optical plate 950 of the Brewster polarizer 945 at Brewster's angle 1115 relative to the focal axis 1105 of the photoelectric sensor 205 to polarize the light. With the optical plate 950 oriented at the Brewster's angle 1115, the light can be readily polarized without the need of additional filters. Not only does this simplify the construction and reduce the cost of the photoelectric sensor 205, this construction enhances accuracy of the photoelectric sensor 205.

FIG. 21 shows how the Brewster polarizer 945 polarizes unpolarized (or partially polarized) light. The normal axis 1110 extends perpendicular to the surface 2105 of the Brewster polarizer 945. As depicted, a unpolarized light ray 2110 (e.g., with s-polarization and p-polarization) is directed towards the surface 2105 of the optical plate 950 to have an angle of incidence. While the unpolarized light ray 2110 will be described with reference to linear polarization, it should be recognized that the unpolarized light ray 2110 can have other types of polarizations such as circular or elliptical polarizations in some cases. It should be noted that the p-polarized light, which is based on the German word for parallel, has an electric field polarized parallel to the plane of incidence. In contrast, s-polarized light is perpendicular to the plane of incidence. The “S” in s-polarized light is generally based on the German word “senkrecht” which roughly translates to perpendicular (i.e., to the plane of incidence). As shown, the angle of incidence between the focal axis 1105 and the unpolarized light ray 2110 is at the Brewster's angle 1115 (Θ_{B}). With the optical plate 950 being held by the optics support 940 at the Brewster's angle 1115, the light reflected by the Brewster polarizer 945 generally forms an s-polarized light ray 2115 that mainly includes s-polarized light. The light refracted through the Brewster polarizer 945 generally forms a p-polarized light ray 2120 that mainly includes p-polarized light.

In one form, the optical plate 950 of the Brewster polarizer 945 is a clear, flat glass sheet, but other types of dielectric materials, such as plastic, can be used in other examples. When the optical plate 950 is made of glass, the Brewster's angle 1115 is around 56° to 57° (e.g., 56.3°, but the Brewster's angle 1115 varies depending on the material of the Brewster polarizer 945 as well as the surrounding environment interfacing with the optical plate 950 (e.g., air, water, etc.). Again, having the optical plate 950 oriented at the Brewster's angle 1115 allows the Brewster polarizer 945 to act as a polarizing filter for both the transmitted and received light with a relatively inexpensive sheet of glass or plastic. This in turn helps to eliminate the need for extra polarizing filters. In essence, the single Brewster polarizer 945 does the work of two polarizing filters as well as provides additional benefits of redirecting the light laterally so as to reduce the impact of extraneous light.

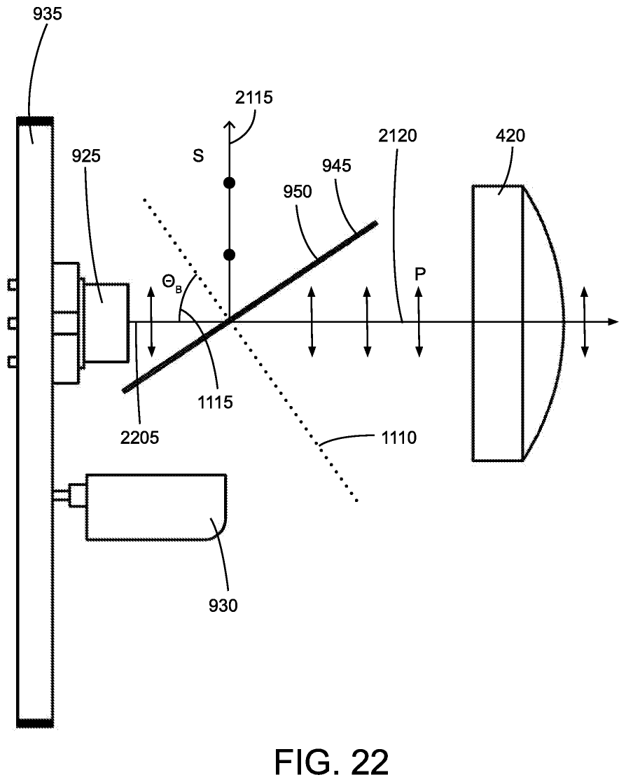

Turing to FIG. 22, the technique will be described with reference to the polarized light source 925 being a laser beam generator, but other types of polarized light sources can be used with this technique. By using the laser to generate the transmitted light, the resulting laser beam will be naturally polarized. As shown, the polarized light source 925 emits an emitted light beam 2205 that is polarized. In particular, the emitted light beam 2205 is p-polarized relative to the Brewster polarizer 945 so that emitted light beam 2205 can mainly pass through the Brewster polarizer 945. The emitted light beam 2205 from the polarized light source 925 hits the optical plate 950 at the Brewster's angle 1115 such that the Brewster polarizer 945 acts as a polarizer for the emitted light beam 2205. Although laser beams are naturally polarized, some discrepancies in the alignment of the components as well as optical and/or electrical defects in the polarized light source 925 may create some other polarizations. The Brewster polarizer 945 further reduces any other polarizing components such that the emitted light beam 2205 forms the p-polarized light ray 2120. As shown, any s-polarized light from the emitted light beam 2205 is reflected off the Brewster polarizer 945 to form the s-polarized light ray 2115. The s-polarized light ray 2115 for the emitted light beam 2205 is directed away from the light detector 930 to avoid light pollution, and the resulting emitted light beam 2205 is absorbed by the walls of the housing 405. In one form, the housing 405 is made of a light absorbing material like a black plastic. As should be recognized, the Brewster polarizer 945 helps to clean up the polarization of the laser beam being emitted by the polarized light source 925. As can be seen, the emitted light beam 2205 forming the p-polarized light ray 2120 is emitted from the photoelectric sensor 205 by passing through the lens 420.

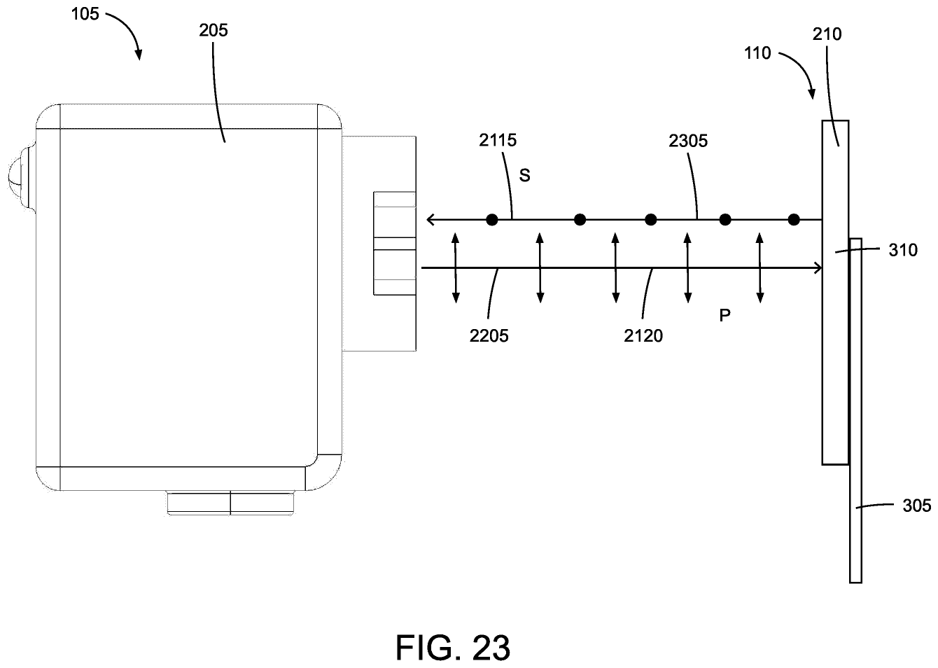

Looking at FIG. 23, the p-polarized emitted light beam 2205 is directed towards the reflector section 310 of the retroreflector 210. As can be seen, the emitted light beam 2205 is reflected off the reflector section 310 of the retroreflector 210 to form a reflected light beam 2305. The retroreflector 210 reduces scattering of the reflected light beam 2305 and directs the reflected light beam 2305 directly back towards the photoelectric sensor 205. Moreover, the retroreflector 210 changes the polarization of the reflected light by ninety degrees (90°) such that the p-polarized light ray 2120 of the emitted light beam 2205 is converted to the s-polarized light ray 2115 for the reflected light beam 2305. To put it another way, the retroreflector 210 changes the polarization of the reflected light to S-polarization.

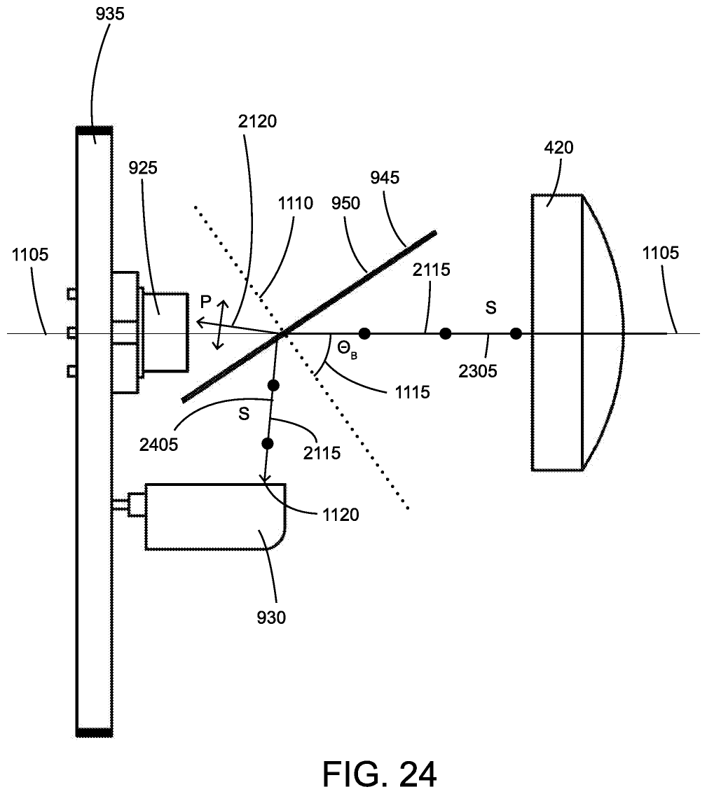

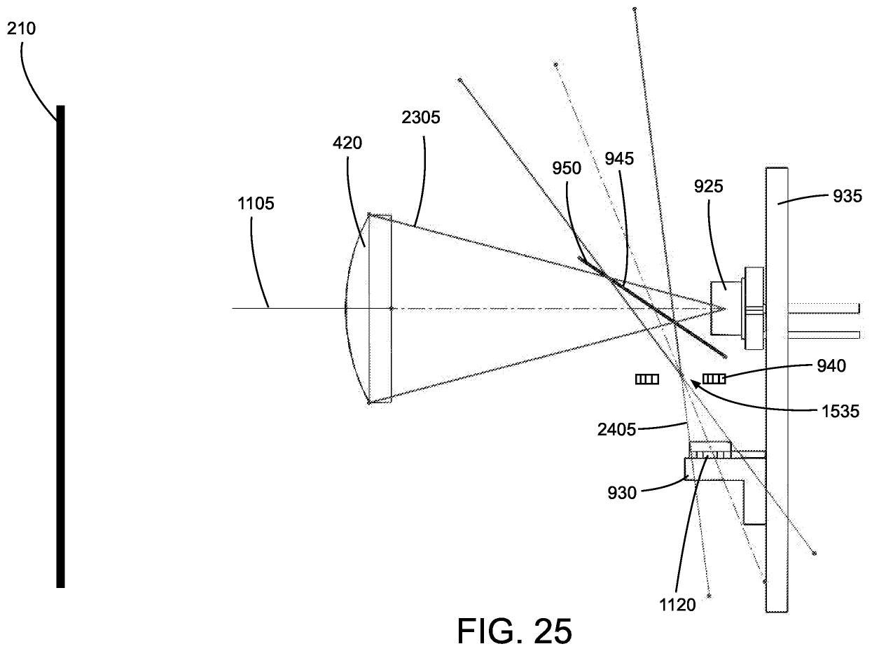

The lens 420 acts as a collimator to focus the reflected light beam 2305, as is shown in FIGS. 24 and 25. The s-polarized reflected light beam 2305 is reflected off the Brewster polarizer 945 at the Brewster's angle 1115. By the optical plate 950 being oriented at the Brewster's angle 1115, the s-polarized light ray 2115 is reflected off the Brewster polarizer 945 to form a detected light beam 2405 that is detected by the light detection surface 1120 of the light detector 930. Any p-polarized light component of the reflected light beam 2305 is refracted through the Brewster polarizer 945 which is shown by p-polarized light ray 2120 in FIG. 24. The lens 420, as is shown in FIG. 25, collimates the reflected light beam 2305 such that the detected light beam 2405 reflected by the Brewster polarizer 945 is focused to form a small beam that passes through the relatively small pinhole 1535 in the optics support 940. Again, the optics support 940 shades or shields the light detector 930 from extraneous light which reduces sensing errors. In addition, the detected light beam 2405 is reflected generally in a lateral direction relative to the focal axis 1105 such that the light detection surface 1120 generally faces the focal axis 1105 so as to be less prone to light pollution from outside the housing 405.

Referring to FIGS. 1, 23, and 24, when one or more of the objects 125 move between the photoelectric sensor 205 and the retroreflector 210, the objects 125 block the emitted light beam 2205 such that the reflected light beam 2305 does not return back to the photoelectric sensor 205. The light detector 930 in turn senses the absence or low intensity of the detected light beam 2405 which indicates the objects 125 are passing in front of the photoelectric sensor 205. In other words, when the s-polarized light ray 2115 shining on the light detection surface 1120 of the light detector 930 falls below a threshold from the s-polarized detected light beam 2405, the photoelectric sensor 205 sends a signal to the controller 115 that the object 125 is passing between the photoelectric sensor 205 and retroreflector 210. Alternatively or additionally, the photoelectric sensor 205 can lighten (or darken) the indicator 510 to indicate that the photoelectric sensor 205 has detected at least one of the objects 125.

The photoelectric sensor system 100 is also designed to detect highly reflective or shiny objects 125. With traditional photo eyes, when a highly reflective or shiny object passes in front of the photo eye, the object acts as a mirror and reflects the light back to the photo eye. The photo eye then senses the reflected light. Since the light beam seems to be uninterrupted, the traditional photo eye in turn incorrectly interprets the situation and does not sense the highly reflective object. As explained before, the photoelectric sensor system 100 uses the retroreflector 210 to change the polarity of the light.

Once more, the photoelectric sensor 205 described herein emits the emitted light beam 2205 as p-polarized light. The retroreflector 210 changes the p-polarized light ray 2120 from the photoelectric sensor 205 to the s-polarized light ray 2115 forming the reflected light beam 2305 (FIG. 23). With the Brewster polarizer 945 reflecting the reflected light beam 2305, the light detector 930 is only able to detect the s-polarized light ray 2115. Unlike the retroreflector 210, the reflective or shiny objects 125 do not change the polarization of the reflected light beam 2305 such that any light reflected from the shiny objects 125 has the same p-polarization as the emitted light beam 2205. When at least one of the reflective or shiny objects 125 passes between the photoelectric sensor 205 and the retroreflector 210, the reflected light beam 2305 remains at the p-polarization. With the reflected light beam 2305 being p-polarized, the optical plate 950 at the Brewster's angle 1115 does not reflect the light towards the light detector 930 (FIG. 24). Consequently, the light detector 930 is able to detect the lower intensity or interruption of the light so as to detect the shiny object 125.

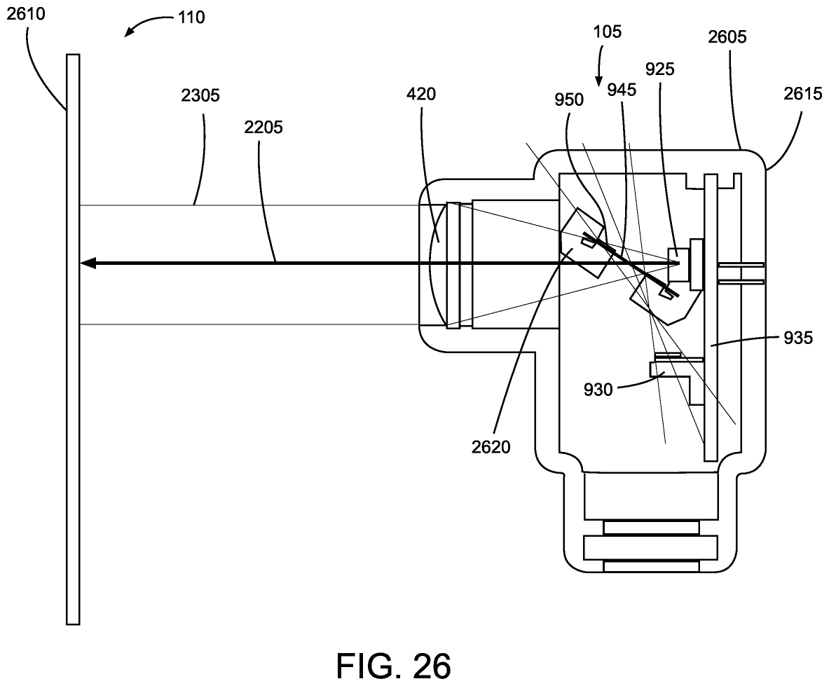

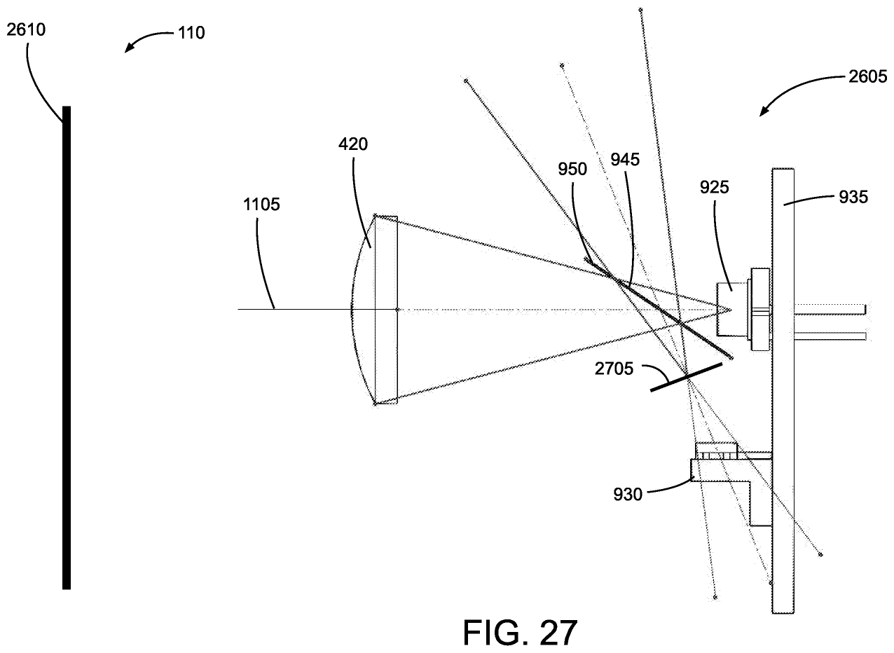

FIGS. 26 and 27 illustrate a photoelectric sensor 2605 according to another example. As can be seen, the photoelectric sensor 2605 shares a number of components in common with the FIG. 2 photoelectric sensor 205 described before and operates in a similar fashion as the photoelectric sensor 205. For sake of brevity as well as clarity, these common features will not be again discussed in detail, so please refer to the previous discussion. As should be further recognized, the different components and other features from each design can be integrated into the other design. Like in the previous example, the photoelectric sensor 2605 emits the p-polarized emitted light beam 2205 from the polarized light source 925 and through the lens 420 which is reflected off a retroreflector 2610 of a type similar to the one described before. The retroreflector 2610 changes the polarity such that the reflected light beam 2305 is s-polarized. The optical plate 950 of the Brewster polarizer 945 which is oriented at the Brewster's angle 1115 (FIG. 21) reflects the reflected light beam 2305 towards light detector 930 that is mounted on the circuit board 935. The light detector 930 is mounted in a transverse or laterally offset manner relative to the polarized light source 925 that is mounted to the circuit board 935. Like before, the light detector 930 detects the objects 125 when the s-polarized reflected light beam 2305 is interrupted or the intensity drops below a threshold level.

Unlike the previous example, the photoelectric sensor 2605 has a housing 2615 with an integrated holder 2620 that holds the optical plate 950 at the Brewster's angle 1115. Once more, the lens 420 collimates the reflected light beam 2305, and the Brewster polarizer 945 at the Brewster's angle 1115 is used to polarize or clean up the polarity of the emitted light beam 2205 and the reflected light beam 2305. As shown in FIG. 27, the photoelectric sensor 2605 further includes a polarizer 2705 that is located along the reflected light path between the Brewster polarizer 945 and the light detector 930. The polarizer 2705 in one form includes a wire grid type polarizer or a dichroic type polarizer. The polarizer 2705 further aids in cleaning up the polarity of the s-polarized light reflected off the Brewster polarizer 945 to enhance sensing accuracy. In one form, the polarizer 2705 includes an absorptive type polarizer such as a polarizing filter, but in other examples, the polarizer 2705 can include other types of polarizers. It should be recognized that the polarizer 2705 can be incorporated into the FIG. 2 photoelectric sensor 205. For example, the polarizer 2705 can be positioned on, over, below, and/or inside the pinhole 1535 in the optics support 940.

### Glossary of Terms

The language used in the claims and specification is to only have its plain and ordinary meaning, except as explicitly defined below. The words in these definitions are to only have their plain and ordinary meaning. Such plain and ordinary meaning is inclusive of all consistent dictionary definitions from the most recently published Webster's dictionaries and Random House dictionaries. As used in the specification and claims, the following definitions apply to these terms and common variations thereof identified below.

“Angle of Incidence” or “Incidence Angle” generally refers to the angle between a ray incident on a surface and a line perpendicular to the surface at the point of incidence which is called the normal. The ray can be formed by any types of waves such as optical, acoustic, microwave, and/or X-ray waves, to name just a few.

“Brewster Polarizer”, “Brewster Window”, or “Brewster Plate” generally refers to a reflective type polarizer that polarizes light with one or more optical sheets tilted at the Brewster's angle. With a Brewster polarizer, no p-polarized light is reflected from the surface of the plates such that all reflected linear light is generally s-polarized. In one example, a single plate, such as of glass or plastic, is used as the Brewster polarizer, but in other examples, multiple stacked plates can be used. In one example, the Brewster polarizer includes a stack of glass plates titled at the Brewster's angle relative to the light beam. In this example, some of the s-polarized light is reflected from each surface of each plate. With the stack of plates, each reflection depletes the incident beam of s-polarized light, thereby leaving a greater fraction of p-polarized light in the transmitted beam at each stage. For visible light in air and typical glass, the Brewster's angle is about 57° such that about 16% of the s-polarized light present in the beam is reflected for each air-to-glass or glass-to-air transition.

“Brewster's Angle” or “Polarization Angle” generally refers to an angle of incidence at which an incident beam of unpolarized light is reflected from an uncoated optical surface after complete polarization (i.e., to s-polarized light), and there is no reflection of p-polarized light from the uncoated optical surface. In other words, the Brewster's angle is an angle of incidence at which light with a particular polarization is perfectly transmitted through a transparent dielectric surface, with no reflection, and when unpolarized light is incident at the Brewster's angle, the light that is reflected from the optical surface is polarized. When light impinges on a flat boundary between two different transparent media, generally at least some part of the optical power of the light is reflected. However, when at the Brewster's angle that reflection does not occur provided that the light is p-polarized, and for s-polarized light, the reflectivity at the Brewster's angle is even higher than for light with normal incidence on the boundary. In some cases, the light passing through the optical media will be at least partially p-polarized such that the light may have some other polarization components. The magnitude of Brewster's angle depends on the refractive indices of the involved optical media and can be calculated with the following equation (Brewster's law):

Θ_{B}=arctan (n₂/n₁)

where:

Θ_{B}=Brewster's angle;

n₁=refractive index of a first medium; and

n₂=refractive index of a second medium.

As a nonlimiting example for this equation, air normally has a refractive index of about 1 (n1≈1) and a glass has a refractive index of about 1.5 (n2≈1.5). With this interface, the Brewster's angle would be calculated to be about 56.3°. By way of nonlimiting examples, the Brewster's angles for diamond, glass, and water are about 67.5°, 57° and 53°, respectively, relative to air.

“Collimator” generally refers to a device that narrows a beam of particles and/or waves. For example, when narrowing the beam, the directions of motion can become more aligned in a specific direction, such as to make collimated light or parallel rays, and/or the spatial cross section of the beam can become smaller like in beam limiting device. Some nonlimiting examples of optical collimators include curved mirrors or lenses.

“Controller” generally refers to a device, using mechanical, hydraulic, pneumatic electronic techniques, and/or a microprocessor or computer, which monitors and physically alters the operating conditions of a given dynamical system. In one nonlimiting example, the controller can include an Allen Bradley brand Programmable Logic Controller (PLC). A controller may include a processor for performing calculations to process input or output. A controller may include a memory for storing values to be processed by the processor or for storing the results of previous processing. A controller may also be configured to accept input and output from a wide array of input and output devices for receiving or sending values. Such devices include other computers, keyboards, mice, visual displays, printers, industrial equipment, and systems or machinery of all types and sizes. For example, a controller can control a network or network interface to perform various network communications upon request. The network interface may be part of the controller, or characterized as separate and remote from the controller. A controller may be a single, physical, computing device such as a desktop computer or a laptop computer, or may be composed of multiple devices of the same type such as a group of servers operating as one device in a networked cluster, or a heterogeneous combination of different computing devices operating as one controller and linked together by a communication network. The communication network connected to the controller may also be connected to a wider network such as the Internet. Thus a controller may include one or more physical processors or other computing devices or circuitry and may also include any suitable type of memory. A controller may also be a virtual computing platform having an unknown or fluctuating number of physical processors and memories or memory devices. A controller may thus be physically located in one geographical location or physically spread across several widely scattered locations with multiple processors linked together by a communication network to operate as a single controller. Multiple controllers or computing devices may be configured to communicate with one another or with other devices over wired or wireless communication links to form a network. Network communications may pass through various controllers operating as network appliances such as switches, routers, firewalls or other network devices or interfaces before passing over other larger computer networks such as the Internet. Communications can also be passed over the network as wireless data transmissions carried over electromagnetic waves through transmission lines or free space. Such communications include using WiFi or other Wireless Local Area Network (WLAN) or a cellular transmitter/receiver to transfer data.

“Conveyor” is used in a broad sense to generally refer to a mechanism that is used to transport something, like an item, box, container, and/or SKU. By way of nonlimiting examples, the conveyor can include belt conveyors, wire mesh conveyors, chain conveyors, electric track conveyors, roller conveyors, cross-belt conveyors, vibrating conveyors, and skate wheel conveyors, to name just a few. The conveyor all or in part can be powered or unpowered. For instance, sections of the conveyors can include gravity feed sections.

“Couple” or “Coupled” generally refers to an indirect and/or direct connection between the identified elements, components, and/or objects. Often the manner of the coupling will be related specifically to the manner in which the two coupled elements interact.

“Electromagnetic Radiation” generally refers to energy radiated by electromagnetic waves. Electromagnetic radiation is produced from other types of energy and is converted to other types when it is destroyed. Electromagnetic radiation carries this energy as it travels moving away from its source at the speed of light (in a vacuum). Electromagnetic radiation also carries both momentum and angular momentum. These properties may all be imparted to matter with which the electromagnetic radiation interacts as it moves outwardly away from its source. Electromagnetic radiation changes speed as it passes from one medium to another. When transitioning from one media to the next, the physical properties of the new medium can cause some or all of the radiated energy to be reflected while the remaining energy passes into the new medium. This occurs at every junction between media that electromagnetic radiation encounters as it travels. The photon is the quantum of the electromagnetic interaction and is the basic constituent of all forms of electromagnetic radiation. The quantum nature of light becomes more apparent at high frequencies as electromagnetic radiation behaves more like particles and less like waves as its frequency increases.

“Fastener” generally refers to a hardware device that mechanically joins or otherwise affixes two or more objects together. By way of nonlimiting examples, the fastener can include bolts, dowels, nails, nuts, pegs, pins, rivets, screws, and snap fasteners, to just name a few.

“Flat” generally refers to a smooth and even surface without marked lumps and/or indentations.

“Frame” generally refers to a structure that forms part of an object and gives strength and/or shape to the object.

“Laser” or “Light Amplification by Stimulated Emission of Radiation” generally refers to a device that utilizes the natural oscillations of atoms and/or molecules between energy levels for generating a beam of coherent electromagnetic radiation usually (but not always) in the ultraviolet, visible, or infrared regions of the spectrum. A laser differs from other sources of light in that it emits light coherently such as spatially and temporally. The resulting spatial coherence allows the laser to be focused to a tight spot and also allows a laser beam to stay narrow over great distances (e.g., collimation). The high temporal coherence of lasers allows the laser to emit light within a very narrow spectrum, such as a single color of light, light with a specific phase, and/or light with a specific polarity. Alternatively or additionally, the temporal coherence can be used to produce pulses of light with a broad spectrum but with short durations (e.g., pulses). The light for the laser includes electromagnetic radiation of any frequency and not just visible light. For example, lasers can include microwave, infrared, ultraviolet, X-ray, and gamma-ray type lasers. Lasers operating at microwave and radio frequencies are commonly referred to as “masers.” Lasers can produce continuous waves of light or pulses of light. Some non-limiting examples of lasers include gas, chemical, excimer, solid-state, fiber, photonic crystal, semiconductor, dye, and free-electronic lasers, to name just a few.

“Lateral” generally refers to being situated on, directed toward, or coming from the side.

“Light” generally refers to electromagnetic radiation of any wavelength, whether visible or not.

“Longitudinal” generally relates to length or lengthwise dimension of an object, rather than across.

“Output Device” generally refers to any device or collection of devices that is controlled by electronics to produce an output. This includes any system, apparatus, or equipment receiving signals from a computer to control the device to generate or create some type of output. Examples of output devices include, but are not limited to, screens or monitors displaying graphical output, any projecting device projecting a two-dimensional or three-dimensional image, any kind of printer, plotter, or similar device producing either two-dimensional or three-dimensional representations of the output fixed in any tangible medium (e.g. a laser printer printing on paper, a lathe controlled to machine a piece of metal, or a three-dimensional printer producing an object). An output device may also produce intangible output such as, for example, data stored in a database, or electromagnetic energy transmitted through a medium or through free space such as audio produced by a speaker controlled by the computer, radio signals transmitted through free space, or pulses of light passing through a fiber-optic cable.

“Plane of Incidence”, “Incidence Plane”, or “Meridional Plane” generally refers to a plane which contains a surface normal and the propagation vector of the incoming radiation when describing reflection and refraction optics. The angle of incidence is typically measured in the plane of incidence.

“Polarization” generally refers to a property of transverse waves, such as light or other radiation, that specifies the geometrical orientation of the oscillations. In a transverse wave, the direction of the oscillation is perpendicular to the direction of motion of the wave. The act of polarization restricts the vibrations of the transverse wave wholly or partially to one direction. The polarization for example can include linear, circular and/or elliptical polarizations.

“Polarizer” generally refers to an optical device that lets light waves of a specific polarization pass while blocking and/or reflecting light waves of other polarizations along a particular light path. A polarizer can convert a beam of light of undefined or mixed polarization into a beam of well-defined polarization. Polarizers can for example include linear and circular polarizers. By way of nonlimiting examples, polarizers can include reflective, dichroic, and birefringent type polarizers. Linear types of polarizers can also be categorized as absorptive or beam-splitting type polarizers. Absorptive polarizers, such as certain crystals (e.g., tourmaline), preferentially absorb light polarized in a particular direction. Beam-splitting polarizers split an incident light beam into two beams of differing polarization (e.g., s-polarization and p-polarization). Some examples of beam-splitting polarizers include Fresnel reflection, birefringent, thin film, and wire-grid type polarizers. One example of a Fresnel reflection type polarizer includes a Brewster's window or plate type polarizer.

“P-Polarization” or “P-Polarized Light” generally refers to light with an electric field polarized parallel to a plane of incidence. In other words, P-polarized light is incident linearly polarized light with polarization direction lying in the plane of incidence. The “P” in p-polarization is generally based on the German word for parallel (i.e., relative to the plane of incidence).

“Retroreflector”, “Retroflector”, or “Cataphote” generally refers to a device and/or surface that reflects electromagnetic radiation, such as light, back to its source with a minimum of scattering. The retroreflector generally reflects the light back along the incident path, irrespective of the angle of incidence. The wave front of the electromagnetic radiation is reflected from the retroreflector straight back to the source of the wave front. A planar mirror in contrast only reflects the wave front that is exactly perpendicular to the mirror (i.e., a zero angle of incidence). Unlike a planar mirror, the retroreflector reflects electromagnetic radiation back to the source across at a wide range of angle of incidences. The reflection from a retroreflector is typically brighter than that of a diffuse reflector. In some cases, the retroreflector generally changes the polarity of the reflected light by ninety degrees (90°). Some nonlimiting examples of retroreflectors include corner, cat's eye, and phase-conjugate mirror type retroreflectors.

“Sensor” generally refers to an object whose purpose is to detect events and/or changes in the environment of the sensor, and then provide a corresponding output. Sensors include transducers that provide various types of output, such as electrical and/or optical signals. By way of nonlimiting examples, the sensors can include pressure sensors, ultrasonic sensors, humidity sensors, gas sensors, motion sensors, acceleration sensors, displacement sensors, force sensors, optical sensors, and/or electromagnetic sensors. In some examples, the sensors include barcode readers, RFID readers, and/or vision systems.

“S-Polarization” or “S-Polarized Light” generally refers to light with an electric field polarized perpendicular to a plane of incidence. In other words, S-polarized light has linear polarization perpendicular to the plane of incidence. The “S” in s-polarization is generally based on the German word “senkrecht” which roughly translates to perpendicular (i.e., relative to the plane of incidence).

“Substantially” generally refers to the degree by which a quantitative representation may vary from a stated reference without resulting in an essential change of the basic function of the subject matter at issue. The term “substantially” is utilized herein to represent the inherent degree of uncertainty that may be attributed to any quantitative comparison, value, measurement, and/or other representation.

“Transverse” generally refers to things, axes, straight lines, planes, or geometric shapes extending in a non-parallel and/or crosswise manner relative to one another. For example, when in a transverse arrangement, lines can extend at right angles or perpendicular relative to one another, but the lines can extend at other non-straight angles as well such as at acute, obtuse, or reflex angles. For instance, transverse lines can also form angles greater than zero (0) degrees such that the lines are not parallel. When extending in a transverse manner, the lines or other things do not necessarily have to intersect one another, but they can.

“Visible Light” generally refers electromagnetic radiation in the visible spectrum that is visible to the human eye. Visible light is usually defined as having wavelengths in the range of 400-700 nanometers (nm), between the infrared and ultraviolet wavelengths.

It should be noted that the singular forms “a,” “an,” “the,” and the like as used in the description and/or the claims include the plural forms unless expressly discussed otherwise. For example, if the specification and/or claims refer to “a device” or “the device”, it includes one or more of such devices.

It should be noted that directional terms, such as “up,” “down,” “top,” “bottom,” “lateral,” “longitudinal,” “radial,” “circumferential,” “horizontal,” “vertical,” etc., are used herein solely for the convenience of the reader in order to aid in the reader's understanding of the illustrated embodiments, and it is not the intent that the use of these directional terms in any manner limit the described, illustrated, and/or claimed features to a specific direction and/or orientation.

The term “or” is inclusive, meaning “and/or”.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by the following claims are desired to be protected. All publications, patents, and patent applications cited in this specification are herein incorporated by reference as if each individual publication, patent, or patent application were specifically and individually indicated to be incorporated by reference and set forth in its entirety herein.

### REFERENCE NUMBERS

Reference Numbers

| | |
|---|---|
| 100 | photoelectric sensor system |
| 105 | photoelectric sensor |
| 110 | reflector |
| 115 | controller |
| 120 | conveyor |
| 125 | objects |
| 205 | photoelectric sensor |
| 210 | retroreflector |
| 305 | frame |
| 310 | reflector section |
| 405 | housing |
| 410 | lens section |
| 415 | mount section |
| 420 | lens |
| 505 | output device |
| 510 | indicator |
| 515 | connector opening |
| 905 | housing body |
| 910 | body cavity |
| 915 | cover |
| 920 | optics system |
| 925 | polarized light source |
| 930 | light detector |
| 935 | circuit board |
| 940 | optics support |
| 945 | Brewster polarizer |
| 950 | optical plate |
| 1105 | focal axis |
| 1110 | normal axis |
| 1115 | Brewster's angle |
| 1120 | light detection surface |
| 1205 | aperture |
| 1210 | indicator opening |
| 1215 | support pins |
| 1220 | board guide |
| 1225 | guide tabs |
| 1305 | guide slot |
| 1405 | support pins |
| 1410 | alignment flanges |
| 1415 | guide slot |
| 1420 | support gap |
| 1505 | window opening |
| 1510 | window frame |
| 1515 | window channel |
| 1520 | support aperture |
| 1525 | shade wall |
| 1530 | pinhole wall |
| 1535 | pinhole |
| 1540 | pin openings |
| 1545 | body pin openings |
| 1550 | cover pin openings |
| 1555 | board contact rail |
| 1560 | housing contact face |
| 1565 | alignment tab |
| 2105 | surface |
| 2110 | unpolarized light ray |
| 2115 | s-polarized light ray |
| 2120 | p-polarized light ray |
| 2205 | emitted light beam |
| 2305 | reflected light beam |
| 2405 | detected light beam |
| 2605 | photoelectric sensor |
| 2610 | retroreflector |
| 2615 | housing |
| 2620 | integrated holder |
| 2705 | polarizer |

What is claimed is:

1. A photo sensor system, comprising:
a light detector;
a retroreflector; and
a Brewster polarizer positioned to reflect light from the retroreflector onto the light detector.

2. The photo sensor system of claim 1, further comprising a polarized light source to emit an emitted light beam with a first polarization towards the retroreflector.

3. The photo sensor system of claim 2, wherein the polarized light source is positioned to shine the emitted light beam through the Brewster polarizer.

4. The photo sensor system of claim 3, wherein the retroreflector reflects the emitted light beam to form a reflected light beam having a second polarization.

5. The photo sensor system of claim 4, wherein the second polarization is oriented 90° from the first polarization.

6. The photo sensor system of claim 5, wherein the Brewster polarizer is positioned to reflect the second polarization onto the light detector.

7. The photo sensor system of claim 6, wherein the first polarization is p-polarization and the second polarization is s-polarization.

8. The photo sensor system of claim 2, wherein the polarized light source includes a laser.

9. The photo sensor system of claim 2, wherein the light detector is positioned laterally offset relative to a focal axis of the polarized light source.

10. The photo sensor system of claim 9, wherein the light detector has a light detection surface that faces the focal axis.

11. The photo sensor system of claim 10, further comprising a circuit board to which the light detector and the polarized light source are secured.

12. The photo sensor system of claim 11, further comprising a housing with a board guide in which the circuit board is received.

13. The photo sensor system of claim 11, further comprising an indicator operatively coupled to the circuit board.

14. The photo sensor system of claim 1, wherein the Brewster polarizer includes an optics support supporting an optical plate at a Brewster's angle.

15. The photo sensor system of claim 14, wherein the optical plate includes a glass plate.

16. The photo sensor system of claim 14, wherein the optics support includes a pinhole wall defining a pinhole through which the light travels to the light sensor.

17. The photo sensor system of claim 16, further comprising a lens positioned between the Brewster polarizer and the retroreflector to collimate the light through the pinhole.

18. The photo sensor system of claim 14, further comprising a housing with one or more support pins to align the optics support in the housing.

19. The photo sensor system of claim 18, wherein the housing has at least three of the support pins.

20. The photo sensor system of claim 14, wherein the optics support has an overall triangular funnel shape.

21. The photo sensor system of claim 1, further comprising a polarizer positioned between the Brewster polarizer and the light detector.

22. The photo sensor system of claim 1, wherein the light detector includes a photodiode.

23. A method, comprising:
emitting an emitted light beam of a first polarity from a light source;
converting polarity of the emitted light beam to a second polarity that is different from the first polarity by reflecting the emitted light beam off a retroreflector to form a reflected light beam that has the second polarity;
reflecting the reflected light beam off a Brewster polarizer towards a light detector; and
detecting the reflected light beam with the light detector.

24. The method of claim 23, further comprising:
sensing an object passing between the light source and the retroreflector by detecting an interruption of the reflected light beam with the light detector.

25. The method of claim 23, further comprising:
cleaning up the first polarity of the emitted light beam by shining the emitted light beam through the Brewster polarizer.

26. The method of claim 23, wherein said reflecting the reflected light beam includes passing the reflected light beam through a polarizer positioned between the Brewster polarizer and the light detector.

27. The method of claim 23, further comprising:
shielding the light detector from extraneous light with an optics support of the Brewster polarizer; and
focusing the reflected light with a lens to pass through a pinhole in the optics support.
